(19) United States
(12) Patent Application Publication
(10) Pub. No.: US 2016/0110467 A1
(43) Pub. Date: Apr. 21, 2016

(54) TAGGED PROXIMITY TRAINING AND TIMING

(71) Applicant: Revolution Technologies, Inc., Del Mar, CA (US)

(72) Inventor: Alexander Hern, Del Mar, CA (US)

(21) Appl. No.: 14/883,963

(22) Filed: Oct. 15, 2015

Related U.S. Application Data
(60) Provisional application No. 62/078,235, filed on Nov. 11, 2014.
(60) Provisional application No. 62/064,666, filed on Oct. 16, 2014.

(51) Int. Cl. G06F 17/30; G06K 7/14

(52) U.S. Cl. CPC G06F 17/30879; G06K 7/1447

(57) ABSTRACT

Tracking the time can be invaluable to companies which send agents into the field where supervising the type, quality, and quantity of service provided can be difficult. The described features ensure that an agent dispatched to a location has been properly trained to perform a requested work order and has spent the proper amount of time at the site to perform the work.

### CROSS-REFERENCE TO RELATED APPLICATIONS

This application claims priority to U.S. Provisional Application No. 62/064,666, filed Oct. 16, 2014 entitled “TAGGED PROXIMITY TRAINING AND TIMING,” and to U.S. Provisional Application No. 62/078,235, filed Nov. 11, 2014 entitled “TAGGED PROXIMITY TRAINING AND TIMING,” each of which is incorporated by reference in its entirety. Any and all priority claims identified in the Application Data Sheet, or any correction thereto, are hereby incorporated by reference under 37 C.F.R. §1.57.

### BACKGROUND

1. Field

The technical field relates generally to improved, context specific, traceable, and authenticated provisioning of training materials.

2. Background

Ensuring a company's agents such as repairmen or other employees' training and activities are properly provided, tracked, and supervised can be essential to providing reliable customer service.

### SUMMARY

Innovative devices and methods for providing training content are described. The features detailed below ensure that an agent dispatched to a location has been properly trained to perform a requested work order and has spent the proper amount of time at the site to perform the work.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 shows a system diagram of an example system for providing tagged proximity training content and time tracking.

FIG. 2 shows a message flow diagram for delivering proximity based content.

FIG. 3 shows a process flow diagram of a method for providing and tracking proximity based content.

FIG. 4 shows a message flow diagram for delivering proximity based content.

FIG. 5 shows a process flow diagram of a method for providing and tracking proximity based content with messaging.

FIG. 6 shows a functional block diagram for an example of a device configured to provide training content.

FIG. 7 shows a functional block diagram for an example device for providing training content.

FIG. 8 shows a functional block diagram of a visit tracking device.

FIG. 9 shows a functional block diagram of an exemplary authentication device.

FIG. 10 is a functional block diagram of an exemplary communications network system in accordance with one embodiment.

FIG. 11A is a functional block diagram of an exemplary wireless communication system in accordance with one embodiment.

FIG. 11B is a functional block diagram of an exemplary implementation of the wireless communication system in FIG. 2A.

FIG. 12 is an exemplary message diagram for creating tags in accordance with one embodiment.

FIG. 13 shows a messaging diagram for an example synchronization session between a client device and a communication server.

FIG. 14A is an exemplary message diagram for creating a conversation thread in accordance with one embodiment.

FIG. 14B is an exemplary message diagram for transacting through a conversation thread in accordance with one embodiment.

FIG. 15 is an exemplary message diagram for receiving and filtering promotional information in accordance with one embodiment.

FIG. 16 is a flowchart for an exemplary method of searching tags in accordance with one embodiment.

FIG. 17 is a flowchart for an exemplary method of creating a conversation thread in accordance with one embodiment.

FIG. 18 is a flowchart for an exemplary method of pausing and unpausing a conversation thread in accordance with one embodiment.

FIG. 19 is a flowchart for an exemplary method of snoozing a conversation thread in accordance with one embodiment.

FIG. 20 is a flowchart for an exemplary method of deleting a conversation thread in accordance with one embodiment.

FIG. 21A is a functional block diagram of an exemplary communications network system in accordance with another embodiment.

FIG. 21B is a functional block diagram of searching with an exemplary communications network system in accordance with another embodiment.

FIG. 22A is an exemplary user interface for a private user profile in accordance with one embodiment.

FIG. 22B is an exemplary user interface for a public user profile in accordance with one embodiment.

### DETAILED DESCRIPTION

One non-limiting advantage of the described systems and methods is self-discovery. Self-discovery is directed to being searchable in the system as a user desires. For example, a company may identify itself, its agents, or specific content with unique tags that are accessible by users of the system. Accordingly, an employee, a customer, or a contractor of the company can search the system for the tag and be presented with the desired content or communication experience. This allows the company to have control over how the content is discovered. It also provides the company the ability to alter the tagged content over time.

Finding content in this manner is very powerful. In many circumstances, it may be desirable to further communicate with the people to discuss the content of the training. One non-limiting advantage of the communication systems and methods described is personally controlled privacy. Features such as unique identifiers for contacts and communications, disclosure or privacy by design, pausing conversations, snoozing or muting conversations, and adding or removing contacts from your network allow the system to provide dynamic real-time management of who, what, and where communications occur.

Such features can be useful for businesses having field agents. As an agent may be remotely deployed, being able to communicate with the agent can be mission critical. The described systems and methods afford a single platform for communicating with field agents whether in the office or in the field provided they are connected to the network. For example, during business hours, if a field agent initiates a communication session with a manager or someone in the home office, the communication session may be routed via voice over IP phone call. However, if the agent is trying to reach someone who is out of the office, the message can be routed via email, for example, to the person of interest or to an alternate backup person.

In one implementation including self-discovery and a central communication engine, the system may be configured to request one or more tags from a user accessing the system via client device. A field agent can be identified by the client device. Prior to leaving the home office, the field agent can add tags to associate the agent's account and the agent's device with the tags and identity established based thereon. This allows the agent to dissociate and port the agent's identity to another device to take advantage of device-neutral identity. For example, the agent may perform credential exchanges to associate the agent with the agent's current device by logging in to the agent's account in the cloud, by establishing wireless or near-field connection, e.g., handshake, between an agent-carried mobile token or fob and a location-specific machines, such as a vending machine, register, billboard, monitor, etc., or by transmitting biometric authentication information, such as fingerprint, retina, iris, voice, face, etc. Once the agent authentication is established, the agent's identity stored within the system can be ported to the authenticated agent device to further the management of self-discovery and communication with others according to the system described herein. Therefore, the agent and the agent's current device provides context to the agent's self-established identity and real-time activities.

A client device may be provided to exchange messages with a central communication server. In addition to contacting the central office for communication purposes, training content may be tagged at the home office. The training content may include material safety data sheets, manuals, maintenance schedules, protocols, sales scripts, or other training content that may be required by the field agent to perform a task. The training content may include audio content, video content, multimedia content, or executable content (e.g., programs).

Providing the content in a contextually appropriate fashion is a further non-limiting advantage of the features described. Consider an agent that comes in close proximity to a beacon which detects the presence of the agent's registered client device. The client device receives a message from the beacon including a tag associated with training content relevant to the location. The client device may be pre-configured to detect the tag (e.g., listening) or may be configured to receive “push” messages to launch the tags application.

The tag includes information for initiating a threadsite mobile application. The agent is then requested to authenticate with the system to determine who he is and what content should be delivered to him. After authentication, his training status is provided and non-completed training (specific to that location, tag, or presence of an item at said location) is displayed. The agent is then able to request training material. The material is then downloaded or otherwise made available on the client device.

The material which is made available to the agent is selected and filtered based on one or more of the location, beacon tag, and agent training status. The material is made available via the threadsite application interface. Thereafter, the agent is able to complete his required training, and submit his completion status to the system. The system is able to save the agent's completion status into the database and send a confirmation. The confirmation may, in some implementations, include what additional training or content is available to the agent. Additionally, the system may track the time between initial beacon contact and departure from the location. Further portions of the session may be identified such as time spent viewing training materials. This can be tracked based on the duration between receipt of training material and a subsequent request via the threadsite application interface for additional or different materials.

Tracking the time can be invaluable to companies which send agents into the field where supervising the type, quality, and quantity of service provided can be difficult. The described features ensure that an agent dispatched to a location has been properly trained to perform a requested work order and has spent the proper amount of time at the site to perform the work.

Consider a further example where a heavy equipment repairman is close to a machine on which he is scheduled to perform maintenance. When the repairman carrying a mobile device, such as a tablet computer, comes in close proximity to the machine which has been fitted with a beacon, the repairman is automatically detected. The repairman then detects a request on his mobile device to initiate a threadsite (e.g., message session) to complete required training or receive updates about his task. The repairman initiates a request to receive information. The system requests that he perform authentication steps to determine who he is, where he is, and/or what content should be delivered to him. The agent completes authentication which may include entering a personal identification number, biometric identification, voice identification, password, or the like. The relevant training content is delivered to the user. The relevant content may be identified based on the past training history for the agent as well as the future task about to be performed.

The repairman is able to message his supervisor via threadsite (e.g., message session) if he has questions (or escalations) and the supervisor can respond. The repairman may continue to complete his training and can either finish a module or stop at any point (because the system can determine where he left off). The system is able to save the agent's completion status into the database and send a confirmation.

Various aspects of the disclosure will now be described with regard to certain examples and embodiments, which are intended to illustrate but not limit the disclosure.

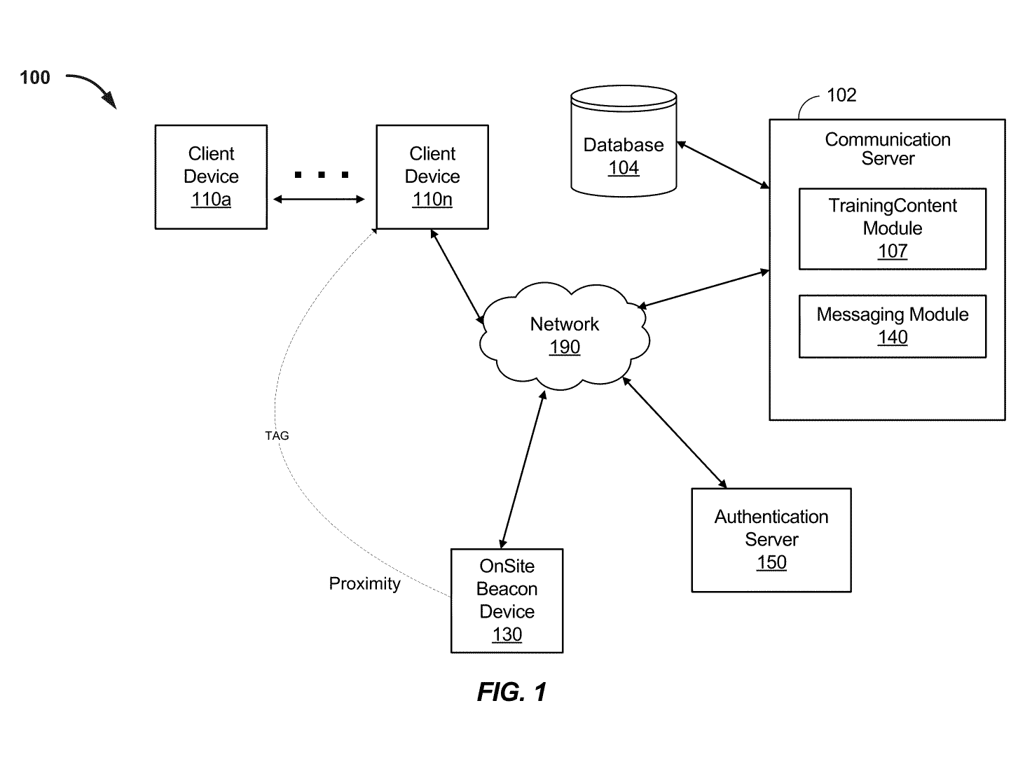

FIG. 1 shows a system diagram of an example system for providing tagged proximity training content and time tracking. The system 100 may be implemented via a client-server architecture where a client device has an application running locally that performs a set of functions that require communication with a server in order to support desired functionality. The client application may be configured to allow users to input their desired request of the application, after which the request is sent to the server for processing. The server may be configured to optionally archive some information (e.g., tags, user contacts information, conversation archives, offers, training content, etc.), and the request may be routed either back to the initiating user and/or to a target user device. The system 100 shown includes multiple client devices (e.g., a client device 110a and a client device 110n). It will be appreciated that fewer or more client devices may be included in the system 100. The client device 110a and the client device 110n (collectively or individually hereinafter referred to as “client device 110”) may be an electronic communication device configured to transmit and receive conversation items in a conversation thread. Examples of such electronic communication devices include smartphones, feature phones, laptop computers, desktop computers, tablet computers, personal digital assistants, set-top devices, gaming consoles, automotive dashboard systems, kiosks, self-service consoles, and the like.

The messages the client device 110 may be configured to transmit and receive may include the tagging, training, and conversation items described herein. The client device 110 may include specialized circuitry configured to transmit, receive, generate, and process the messages discussed in further detail below. In some implementations, the client device 110 may include a processor which is configured to execute stored instructions which cause the client device 110 to transmit, receive, generate, and process the messages described.

The system 100 includes a network 190. The client device 110 may be configured to transmit and receive messages via the network 190. Examples of the network 190 include a wide area network (WAN), metropolitan area network (MAN), local area network (LAN), wireless local area network (WLAN), or personal area network (PAN). Although shown as one network, the network 190 may include several interconnected networks. The networks which may be included in the system 100 may differ according to the switching and/or routing technique used to interconnect the various network nodes and devices (e.g., circuit switching vs. packet switching), the type of physical media employed for transmission (e.g., wired vs. wireless), and the communication protocols used (e.g., Internet protocol suite, SONET (Synchronous Optical Networking), Ethernet, etc.). Regardless of the form the network 190 may take, the network 190 is configured to facilitate machine-to-machine messaging for tagging and communication as described herein.

The system 100 includes on-site information device(s) 130. The on-site information device 130 may also be an electronic communication device configured to transmit messages at a location. For example, the on-site information device 130 may be implemented as a beacon. The beacon may be configured to transmit and receive tagging and communication messages to the client device 110 within, for example, a store. This allows a store owner to configure messages for broadcasting to the client device upon entry into a predetermined area. Sites may include stores, amusement parks, cruise ships, restaurant, hotels, convention centers, arcades, campuses, hospitals, and casinos. The beacon may be included in particular devices such as equipment installed at a client site. Examples of devices which may include a beacon include washing machines, vending machines, computers, printers, copy machines, pianos, refrigerators, manufacturing equipment, vehicles, aquatic vehicles, gaming equipment, or other which may be serviced by a field agent. The beacon may also be included in particular areas of a company. For example, in a laboratory, it may be desirable to ensure that all employees entering a particular lab have the appropriate safety training before working. Accordingly, a beacon may be placed near the lab entries to broadcast one or more tags to the appropriate training content and contact person. In some implementations, the beacon is pre-tagged with unique/specific item number or model number which can trigger specific training material in the system 100 as described.

The beacon may be implemented as disclosed in U.S. Patent Pub. No. 2013/0226704, titled “CONSUMER INTERACTION USING PROXIMITY EVENTS,” U.S. Patent Pub. No. 2013/0254104, titled “CONSUMER INTERACTION USING PROXIMITY EVENTS,” and U.S. Patent Pub. No. 2014/0089111, titled “MOBILE DEVICE ORDER ENTRY AND SUBMISSION USING PROXIMITY EVENTS,” (hereinafter “Beacon Examples”) each of which are expressly incorporated by reference in their entirety.

The on-site information device(s) 130 may communicate directly with the client device 110. In some implementations, the on-site information device(s) 130 may be communication with the client device 110 via the network 190.

The client device 110 may transmit and receive tags, training materials, and communication information. The tags, training materials, and communication information may be processed by a communication server 102. The communication server 102 is configured as a hub to tagging, training materials, and communication activities within the system 100. The communication server 102 is configured to receive tags for user accounts (e.g., a company or agent client device 110). The communication server 102 may be configured to process the received tags such as by verifying the associated account, validating the tag, storing the tag in a database 104, and transmitting global tags via the network 190. The communication server 102 may be configured to provide searching of user accounts. The searching may be based on the tags stored in the database 104. The training content may be associated with a tag and searches for the tag by the appropriate client devices can obtain the training material. The database 104 may store contacts and conversation archives. The database 104 may also store training and proximity history when a client device is detected within an area and training material is provided. In some implementations, the database 104 may store information in an encrypted format via encrypted communication medium. In some implementations, the database may store information for a predetermined period of time. For example, the database 104 may store conversation archives up to 30 days and transaction history up to 7 years.

In some embodiments, the database 104 and/or the communication server 102 may be implemented in a distributed system, in which there are more there are more than one databases 104 and/or communication servers 102. The client devices 110 may be in communication with the various modules illustrated in FIG. 1 using an application programming interface (API). In some embodiments, when a user of the client device 110 connects to the communication server 102, a socket handler process may be created for that user of the client device 110. In some embodiments, chat messages targeted at a user of the client devices 110 may be delivered using the socket handler corresponding to the target user. If the message needs to be delivered to a disconnected user, a third-party push notification service can be used, for example. The system 100 implemented in a distributed network may include one or more load balancers configured to distribute the load across all available instances of communication service, for example. In some embodiments, the load balancers based on hardware, nginx, HAProxy, or other similar solutions. In embodiments using an API layer, the API layer may forward all re1quests to the service layer, and all incoming requests can be targeted either at a user or a chat. In some embodiments, distributed routing protocol may be deployed across all instances involved in the communication service. Every instance of the communication service, for example, can run several processes that implement the distributed look-up protocol. In such example, each one of the processes can be responsible for an evenly distributed number of chat and socket handler processes, and these processes can be used to forward requests to the corresponding socket handler and chat processes based on, for example a routing key such as a chat or user identifier. In some embodiments, the service layer may include several chat processes, and a chat process can be responsible for managing all the communication to and from the chat it represents, as well as caching information concerning that chat to reduce the number of required database look-ups, for example. In such embodiments, the chat processes can be gracefully terminated after a period of inactivity and requests targeted at chats may require restoring a chat process from its persisted state.

In some embodiments, a messaging module 140 may be implemented using the open telecom platform (OTP) framework. The messaging module 140 may be implemented in a modular manner and can be interfaced using multiple methods such as TCP/IP sockets, HTTP representational state transfer (REST), or Websockets. The messaging module 140 may be implemented in a service-oriented architecture and may consume other internal services for authentication and profile management and other services such as payment and analytics, for example. In some embodiments, the messaging module 140 may consume push notification service. In some embodiments, a mobile application, which may reside in the client device 110, may maintain a bidirectional socket connection. For example, each connected user may have its own process, and each user's geocoordinates may be sent periodically and persisted. In some embodiments, device information and diagnostics can be captured on login.

In some embodiments, transmitting and receiving tags, training content, and communication information may be implemented in a multi-node application for increased scalability. For example, each communication or chat service may be implemented in a node, and scaling the system may involve deploying a new node and adding it a cluster of char service nodes. The multi-node communication service can be implemented in an architecture similar to Riak. For example, all data may be persisted on a Riak back-end, and the database may be based on a masterless system with eventual consistency. In some embodiments, the fulltext indexing service and geospatial search may be implemented with Solr, for example. In one example, the core communication or chat service may have a 160-bit ring, which can be divided into equally sized partitions. The messaging module 140 may include a fixed number of virtual nodes, or vnodes, and may have as many vnodes as partitions in the ring as each virtual node may be responsible for one partition of the ring. The ring may be used to distribute the load across all the nodes used by the communication service. The messaging module 140 may also include user and chat identifiers, which can serve as routing keys. In one embodiment, the requests handled by the chat service may target either a user or a chat, and requests can be routed to the vnode responsible for that user or chat. As nodes join and leave the cluster, the total number of partitions and vnodes may remain the same, for example, and the ring may be rearranged according to a new cluster structure. In such implementations, the responsibility of a vnode on a set of users and chats may be handed over to one or more physical nodes as nodes join and leave the cluster. In some embodiments, by deploying additional nodes and transferring responsibilities, the system may reduce the load on initially overloaded nodes and may balance loads in multiple servers, for example.

In some embodiments, the communication server 102 may be implemented with multicore Linux servers clustered around services. In some embodiments, Riak database services may be implemented in multiple (e.g., 5 or more) physical boxes, and chat service can be implemented in multiple (e.g., 3 or more) servers scaling to dozens. In some embodiments, one or more load balancers may be implemented between mobile clients and the messaging module 140 and between the messaging module 140 and Riak. In some embodiments, firewall may be placed between the messaging module 140 and Riak. Some implementations may use SSL accelerators.

The messaging module 140 may be configured to receive conversation threads for user accounts. The conversation threads may be associated one or more tags. The conversation threads may be associated with one or more user accounts. The messaging module 140 may be configured to also receive distribution information for a given conversation thread. For example, the conversation thread may not be distributed outside a predetermined set of users. As another example, the conversation thread may have limited visibility such as only to users associated with a predetermined tag. Accordingly, when a user performs a search, the conversation thread may be provided if the tags (e.g., global and/or personal) associated with the user satisfy the distribution rules for the conversation thread. As one example, consider a company interested in providing training materials for a product. The merchant may post a conversation thread to their account with a tag “Item1324Manual”. If an agent searches for tag “Item1324Manual”, the conversation thread (and thus the manual) will be provided. Since the tag may be private to the company and its agents, if a person who is not an agent or otherwise affiliated with the company searches for “Item1324Manual”, the conversation thread will not be found. This provides a powerful way for company owners to manage the distribution of proprietary materials to authorized individuals only. For example, after a customer purchases “Item1324,” the company may authorize the customer to associate with the tag “Item1324Manual.” Thereafter, if the customer searches the tag “Item1324Manual”, the new product conversation may be returned to the customer.

The messaging module 140 may further manage the distribution and life of a conversation. For example, the messaging module 140 may pause, snooze or mute an ongoing conversation. The messaging module 140 may also allow a conversation thread to be deleted. Receiving a message to delete a conversation thread may cause the messaging module 140 to ensure the user account requesting the deletion is authorized to do so. If so, the messaging module 140 may transmit one or more messages to client devices to remove the conversation thread. This allows users a higher degree of control over conversation items. Managing conversation may utilize business logic for processing messages to each communication or chat room type, such as broadcast, BCC, threadsite, group chat, single, etc. The conversation thread may be database-backed, and the communication service described herein may provide a caching layer minimizing database load and decreasing latency for the users of the client devices 110.

The communication server 102 may include a training content module 107. The training content module 107 may be configured to provide and track training content. The training content may be provided on demand. The demand which triggers the content delivery may be a search by a user including specific terms or having predetermined account characteristics. The demand may include, for example, the search terms, stored user profile information (e.g., interests, age, home town, gender), current user information (e.g., device type, device connectivity, device operating system, GPS location information for a device), the user's tags, the user's conversations, and usage history for the user.

The demand may be based on proximity sensing via a beacon. For example, a company may deploy a beacon within a client site such as on a device or in a particular location (e.g., lab space). As an agent holding a wireless device (e.g., smartphone, tablet computer) enters a coverage area for the beacon, the wireless device may transmit information to the beacon. The information transmitted to the beacon may include identification information for the device, for a user of the device, and/or for an account associated with the device. The beacon may receive this information and transmit the information to the training content module 107 to receive a customized training for the user. The customization may be based on the information provided by the wireless device. In some circumstances, the user may not have previously established a personal account with the communication server 102. In such cases, information about the device such as the media access control identifier may be used to determine characteristics of the device holder. Characteristics may include device type, device model, and device interactions (e.g., with this or other beacons). In some circumstances, the user may have previously established a personal account with the communication server 102. In doing so, the agent or her employer may have provided tags describing themselves to the world (e.g., self discovery tag). The user may also be associated with private tags assigned by the employer (e.g., self-tagging tags). In such cases, the additional tag data may be used to further select an appropriate training content for the user.

The selection of the training content may be based on training content rules stored in the database 104. A training content rule may include one or more criteria (e.g., device characteristic, tag information, location, date, time, etc.) and an associated training content element. In some implementations, a user may qualify for multiple content elements. The training content rule may specify whether the associated training module has pre-requisites, supersedes other content, or is a default training module in the event another is selected. The training content rules may be provided by the company such as via a client device.

The training content module 107 may be further configured to track a service visit (e.g., repair call). For example, the training content module 107 may identify when an agent arrives at a service site and initiate a timer. The training content module 107 may maintain the timer based on periodic messages transmitted from one or both of the beacon and the client device indicating that the client device is still in proximity to the beacon. Once the training content module 107 determines that the client device is no longer in proximity to the beacon, the timer may be stopped. The duration of time can be determined based on the last point in time when the client device was in proximity to the beacon. The timing information may be stored in the database 104 for further processing such as billing.

Additional timers may be kept by the training content module 107 to track the amount of time spent on particular training content. For example, when the training content module 107 provides access to training content, a timer may be initiated. The timer may be maintained until a subsequent communication is received from the client device 110. The subsequent communication to indicate the end of the timer may be a specific communication such as a request for additional content. This allows the timer to continue for communications from the client device 110 which may be related to the training such as a communication session (e.g., chat) with a supervisor or help desk agent. The timing information may be stored in the database 104 for further processing such as compliance records or providing subsequent training.

The training content module 107 may also obtain information regarding a site such as floor plans, points of contact, service history or the like. The training content module 107 may receive the beacon information (e.g., beacon identifier or tag) and, in some implementations, the location of the client device. This information can be used by the training content module 107 to look up, in the database 104, the site information. The database stores information regarding the training material, supervisors, and on-site representatives and identifies this collection of information by the beacon information and, in some implementations, location information. This allows field agents to quickly obtain information needed to fulfill work requests.

It may be desirable in some implementations to include an authentication server 150. As shown in FIG. 1, the authentication server 150 is in data communication with the client device 110 and the communication server 102 via the network 190. In some implementations, the authentication server 150 may be included in the communication server 102. The authentication server 150 may be included to ensure the training content is provided to authorized individuals. This serves one purpose of protecting the content and limiting access to only those individuals who are approved to receive the content. This also serves to identify who is receiving the training materials. This can be important to prove compliance or completion of training for individuals. The authentication server 150 can be configured to authenticate before providing the training materials such that the recipient of the training materials can be properly identified and authorized. The authentication further provides the information for the system 100 to acknowledge who was at a given location, how long the user was there, and provide relevant training material on-site via mobile device.

In some implementations, one or more of the client device 110 and the communication server 102 may include a tagging module configured to generate one or more tags for content, conversations, or threadsites managed within the system 100. For example, the tagging module may receive training content and may be configured to generate one or more tags based on metadata associated with the training content or the content itself in the database 104. For example, keyword extraction may be performed on a training document to identify core concepts discussed in the training content. These core concepts may be associated as tags for the training content.

The tagging module may be configured to parse user information to generate one or more new tags, and it may be further configured to determine the optimal key words or phrases so that the new tags are not redundant and yet adequately represent automatically gathered user information, for example.

The new tags may be stored in the database 104. In one embodiment, the newly generated tags may be linked with the company's account as well as their agents using the system 100. A search index in the database 104 may be updated reflecting the addition of the new tags and their associations with the accounts and training content.

A representative of the company may select and input on the client device 110 one or more words or phrases to upload training content or threadsites and create additional self tags for each. The self tags may be self-descriptions the content or threadsite is associated with. This self tagging allows each company to leverage their internal vocabulary when referring to training materials without altering the underlying system components.

The client device 110 then may send the user inputted words or phrases and request the tagging module to create self tags for the content or threadsite based on the words or phrases. In one embodiment, the client device 110 may display a message to the user suggesting better tag words or phrases. In another embodiment, the client device 110 may display a message to the user notifying of tagging restrictions and that the tag the user intends to create is too long, spelled incorrectly, inappropriate, or offensive. In one embodiment, the user may be allowed to override the tagging restrictions, and in another embodiment, the user may be allowed to override only some of the tagging restrictions. Such restrictions may be useful when tagging content which is legally required such as training regarding fair labor practices at the company.

Upon receiving the self tag requests, the tagging module may generate one or more tags based on the user inputted words or phrases. The self tags may be stored in the database 104. The self tags may be linked to the company's account in the database 104 so that searching for the tags, for example, would lead to the company's account.

Upon storing the public self tags and linking them to the company's account, a public search index may be updated. Reflecting various implementations of a public search, the public search index may be one of many search indices in the database 104 and may link and organize various tags to optimize public searches. In one embodiment, a public search may be for searching the entire user accounts in the database 104 regardless of whether the search requester has any connection with the users of the user accounts. In another embodiment a public search may be generated for searching the entire user accounts except the ones listed in the search requester's contacts. In another embodiment a public search may be searching the entire accessible conversation threads in the database 104 regardless of the search requester's involvement in the conversation threads. In one embodiment, a public search may be tailored to the search requester's user account. In another embodiment, a public search may be universal to all the user accounts in the database 104.

It should be noted that searches may be of three flavors: public, semi-public, or private. A public search generally refers to a search for managed elements which includes information that is available for viewing by all users of the system. A semi-public search refers to a search for managed elements that are available for viewing by some users of the system. The semi-public search may determine whether the requesting user account is associated with a particular tag or has completed authentication before returning semi-public results. If a managed element is tagged with a semi-public tag, only certain users can access, search for, find, and obtain the managed element. Semi-public tagging may be useful for companies to manage distribution of proprietary manuals, for example, to customers and agents. By associating the customers or agents with a particular tag identifying them as members of the semi-public group, the system 100 may permit the searches to be optimized such that the results available to those members is provided while preventing the public at large from view the results. A private search includes tags that are viewable by the account holder only. The private tags are not searchable or viewable to any users of the system 100 except the user who entered the tag. As such, items tagged privately can only be found by searching which includes the tag information submitted by the user who assigned the tag.

### Proximity Training Content Provision Examples

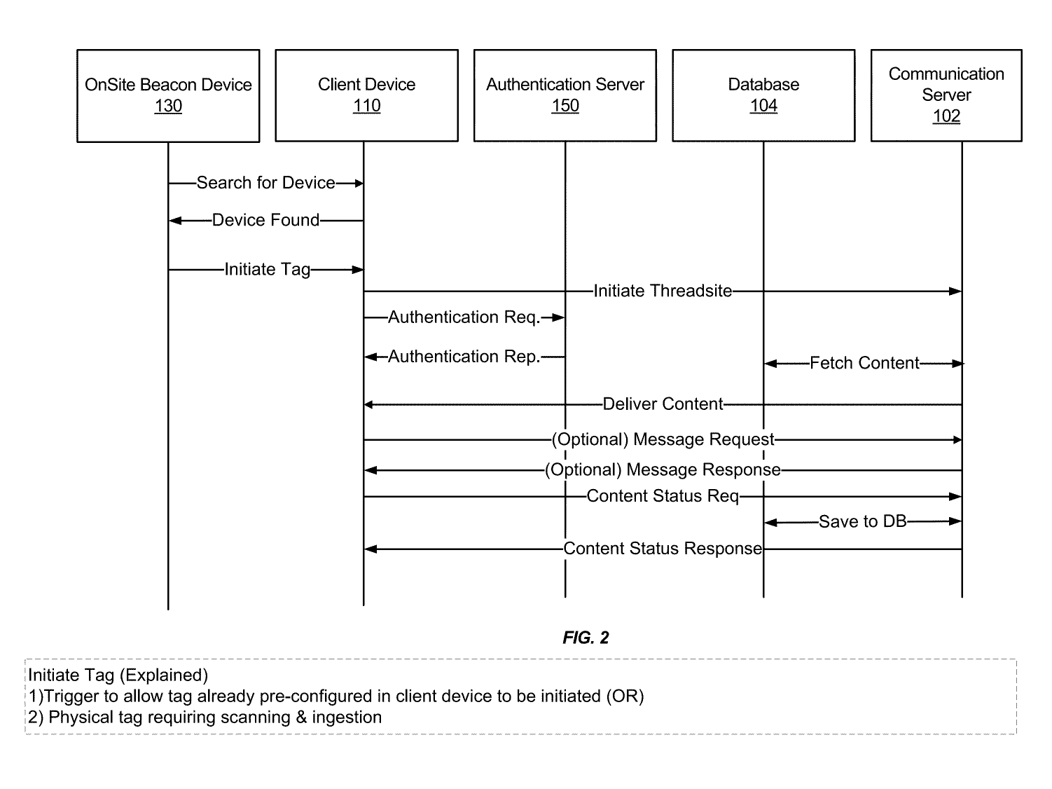

FIG. 2 shows a message flow diagram for delivering proximity based content. The message flow of FIG. 2 shows messages exchanged between several entities which can be included in a communication system. For ease of explanation, the number of entities shown has been limited. However, it will be understood that additional entities can be added or multiple entities combined consistent with the description herein.

The on-site beacon device 130 may broadcast a search message for client devices. The client device 110 may be configured to receive the search message. In response to receiving the search message, the client device 110 may be configured to transmit a search response message indicating the device has been found. The on-site beacon device 130 may then transmit a tag for initiating a threadsite or training content. As shown in FIG. 2, the tag transmitted to the client device 110 is to initiate a threadsite. It will be understood that the on-site beacon device 130 may be implemented as a passive device. In such implementations, the tag information may be scanned and ingested by the client device 110. One example of such an implementation is an RFID beacon device which needs to be read via near field communications initiated by the client device 110. In yet another implementation, the on-site beacon device 130 may not provide the tag to the client device 110 in the broadcast message. Instead, the client device 110 may be preconfigured with the tag information. In such implementations, the beacon may transmit a message triggering the client device 110 to retrieve the preconfigured tag information and initiate the appropriate threadsite and/or training content.

The client device 110 may launch a client application for initiating threadsites via a message transmitted from the client device 110 to the communication server 102. The threadsite may be initiated with basic content and a value indicating the need for authentication. Once the client device 110 determines that authentication is needed based on the initiated threadsite, an authentication request is transmitted from the client device 110 to the authentication server 150. The authentication request may specify the information needed to authenticate the user and/or client device 110 associated therewith.

The authentication server 150 may receive the authentication request and determine whether the information received is authenticated. In some implementations, the authentication server 150 is configured to authenticate individuals. In some implementations, the authentication server 150 may be configured to authenticate individuals in combination with threadsites or particular training content. The authentication server 150 transmits the result of the authentication determination to the client device 110. In some implementations (not shown), the authentication response may also be transmitted to the communication server 102. This allows the communication server 102 to proceed to provide the authorized content to the client device 110.

The communication server 102 may fetch the training content or additional threadsite information from the database 104. The communication server 102 may transmit the content to the client device 110.

FIG. 2 includes optional message request and response messaging. These optional components highlight that the client device 110 may chat or initiate another communication session via the communication server 102. For example, a repair agent may have a question about a particular job. After reviewing the training materials, she may initiate a communication session with a technician who can provide additional guidance on a particular repair. The communication session may include exchanging audio, video, streaming content, text, or other content related to the job.

The client device 110 may transmit a content status request to the communication server 102. The content status request may specify identification information for the agent using the client device 110. The content status request then provides the current status of the agent for the desired content. This can be useful in helping agents continue working through content that may have been previously started, but not completed. The status request may also provoke the system to generate a historical report of training content accessed. As the agent views the content, the content status request may also include the current location. This can preserve the last location of the content for the agent. As shown in FIG. 2, this status information can be saved in the database 104.

A content status response may be transmitted from the communication server 102 to the client device 110. The content status response may include progress information for the current training or information responsive to the content status request such as an overall training history.

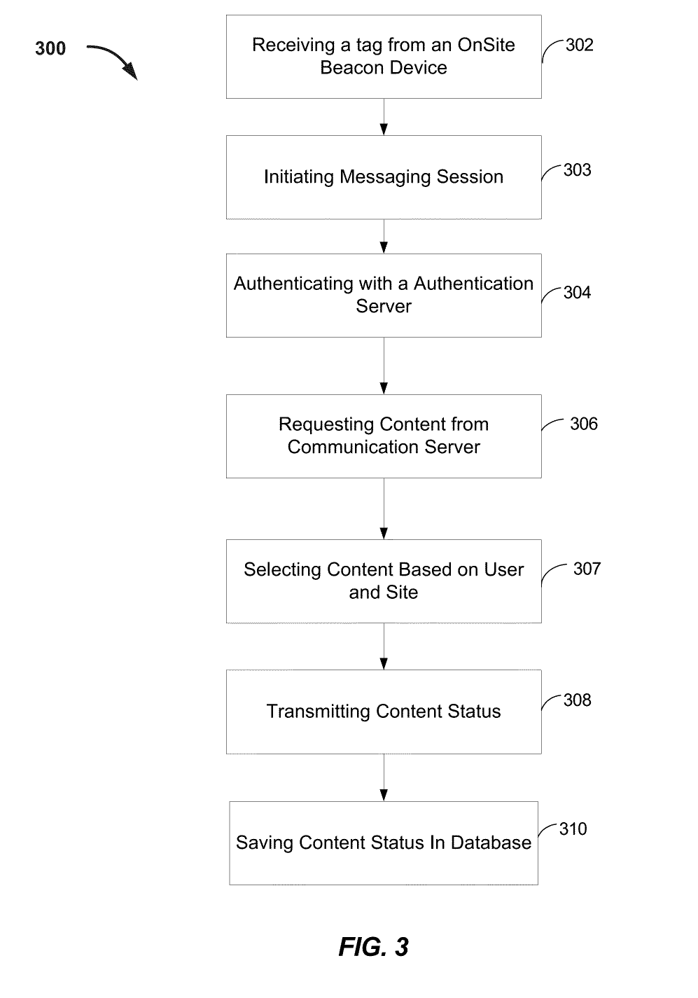

FIG. 3 shows a process flow diagram of a method for providing and tracking proximity based content. The method shown in FIG. 3 may be implemented in whole or in part by one or more of the devices described in FIG. 1.

At block 302, a tag is received from an on-site beacon device. As noted above, the tag may be broadcasted by the beacon device, retrieved based on a triggering message from the on-site beacon device, or obtained through scanning or other means from a passive on-site beacon device.

At block 303, a messaging session is initiated. The initiation of a messaging session may include launching a client application for viewing threadsites. The initiation of the messaging session may be for a point-to-point messaging session (e.g., between two parties) or a group messaging session. For example, once on-site, a repair agent may desire to communicate with all members of his repair team regarding a particular job. Accordingly, a group communication session can allow multiple parties to receive a common message.

At block 304, authentication may be performed with an authentication server. The authentication may be initiated by detection of a value in the messaging session. The authentication may be initiated by virtue of the tag used to initiate the messaging session. The authentication may include receiving authentication information at a client device and securely transmitting the information to an authentication server. As noted above, the authentication may include authenticating the identity of the user alone or in conjunction with the requested content, messaging session, client device, or other factor.

If the authentication fails, it may be desirable to end processing of the method. If the authentication succeeds, at block 306, content is requested from the communication server. The content may be requested as part of the messaging session or a threadsite accessed from or during the messaging session. The request may include user identification information, client device identification information, and on-site beacon identification information.

At block 307, training content is selected. The training content may be selected based on the user identified in the content request. For example, the user may have a training history including completion of a training module. If that training module is identified for delivery and the user has already completed the training module, there is no need to provide this training again. The content request may include the beacon identifier. The beacon is typically associated with a known location. As such, the training content which is relevant to those in proximity to the beacon can be defined by identifying a set of content for each beacon or tag. The definitions along with the content may be stored in the database 104. In some implementations, the tag for a given beacon will take on a different meaning depending on the location of the beacon. For example, consider a company providing services in two states. In the first state, the tag “Item1324Manual” may need to include a product safety disclaimer that is not needed in the second state. As such, the location of the beacon along with the tag may be transmitted and considered for content selection.

The selected content may be provided to a client device. At block 308, content status may be transmitted from the client device to the communication server. The content status may identify how much of the selected content was viewed. The content status may also include timing information identifying how long the client device was displaying the provided content. At block 310, the content status information may be stored in a database.

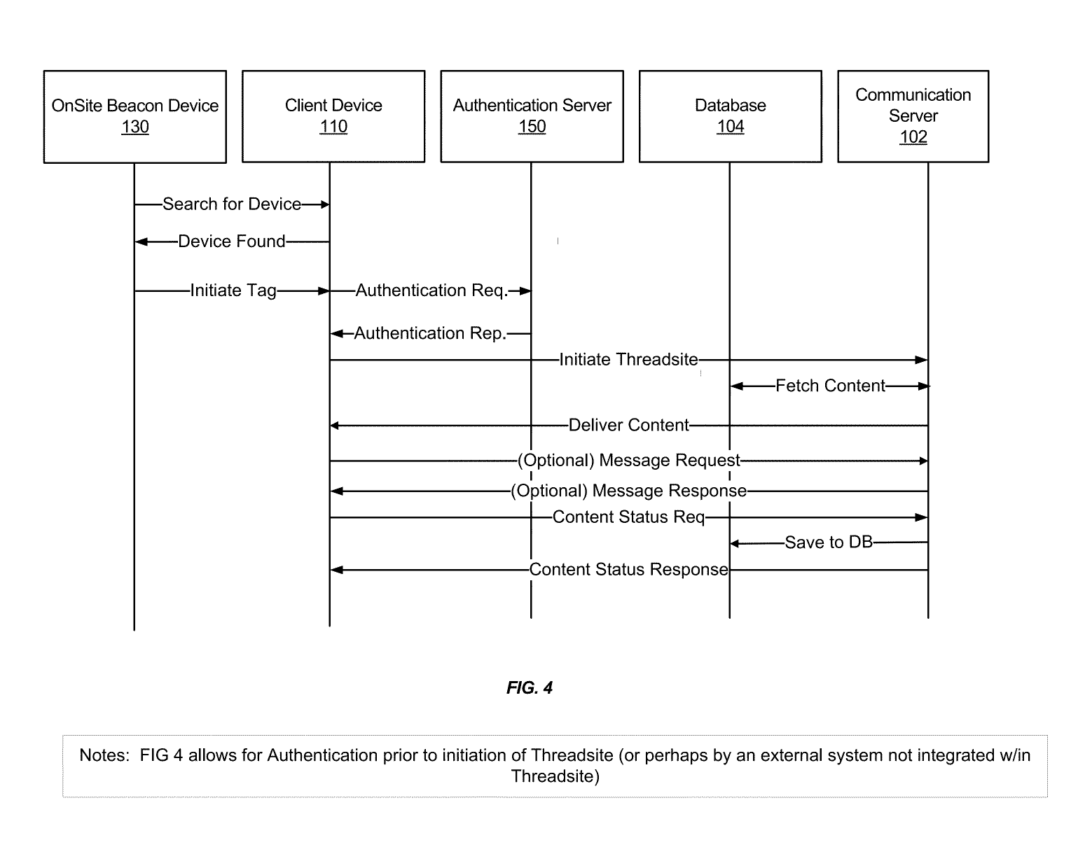

FIG. 4 shows a message flow diagram for delivering proximity based content. The message flow of FIG. 4 shows messages exchanged between several entities which can be included in a communication system. For ease of explanation, the number of entities shown has been limited. However, it will be understood that additional entities can be added or multiple entities combined consistent with the description herein.

The message flow in FIG. 4 is similar to the message flow of FIG. 2 with the exception that the authentication occurs before initiating the threadsite. This ensures that the client device 110 does not receive any information until after authentication is performed.

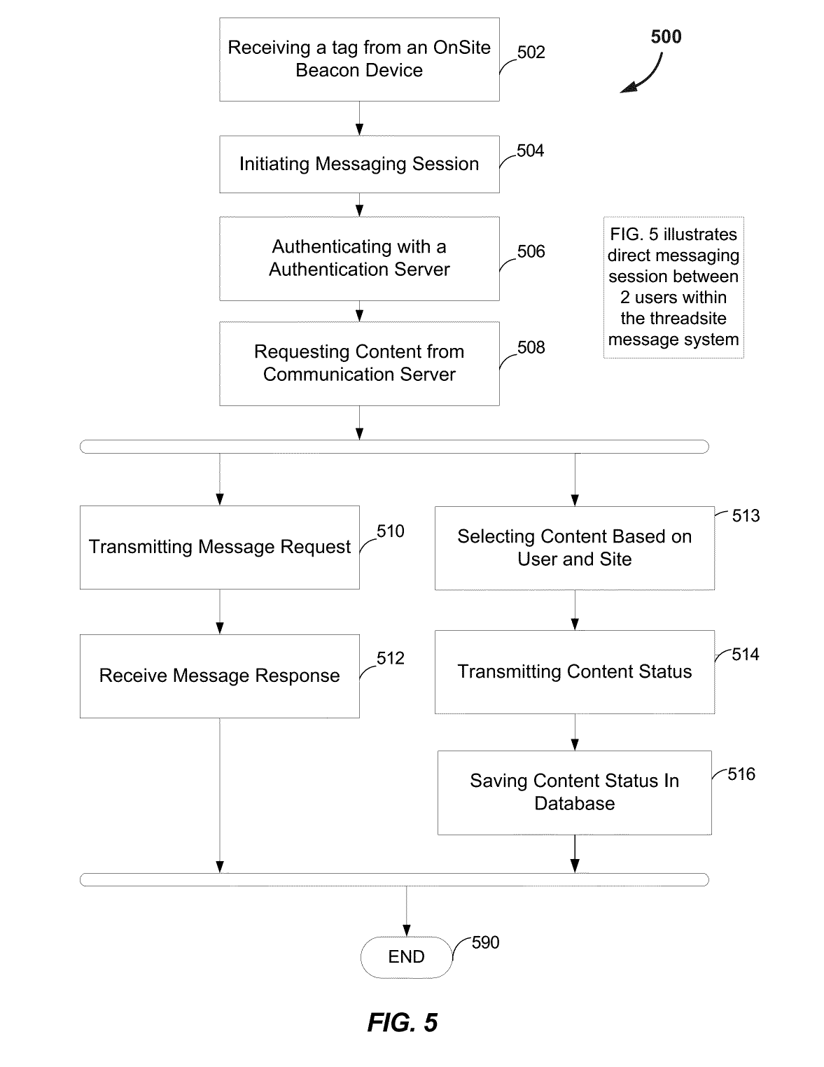

FIG. 5 shows a process flow diagram of a method for providing and tracking proximity based content with messaging. The method shown in FIG. 5 may be implemented in whole or in part by one or more of the devices described in FIG. 1.

The method 500 begins at block 502 when a tag is received from an on-site beacon device. As noted above, the tag may be broadcasted by the beacon device, retrieved based on a triggering message from the on-site beacon device, or obtained through scanning or other means from a passive on-site beacon device.

At block 504, a messaging session is initiated. The initiation of a messaging session may include launching a client application for viewing threadsites. The initiation of the messaging session may be for a point-to-point messaging session (e.g., between two parties) or a group messaging session. For example, once on-site, a repair agent may desire to communicate with all members of his repair team regarding a particular job. Accordingly, a group communication session can allow multiple parties to receive a common message. The method 500 shown in FIG. 5 illustrates a direct messaging session between 2 users within the threadsite message system.

At block 506, authentication may be performed with an authentication server. The authentication may be initiated by detection of a value in the messaging session. The authentication may be initiated by virtue of the tag used to initiate the messaging session. The authentication may include receiving authentication information at a client device and securely transmitting the information to an authentication server. As noted above, the authentication may include authenticating the identity of the user alone or in conjunction with the requested content, messaging session, client device, or other factor.

If the authentication fails, it may be desirable to end processing of the method. If the authentication succeeds, at block 508, content is requested from the communication server. The content may be requested as part of the messaging session or a threadsite accessed from or during the messaging session. The request may include user identification information, client device identification information, and on-site beacon identification information.

As shown in FIG. 5, the request for content may cause the method to begin two parallel activities. The first is the selection, provision, and tracking of content (blocks 513-516). These blocks are substantially similar to blocks 307, 308, and 310 shown and described in reference to FIG. 3. The second activity is initiation of a communication session with another client device. At block 510, a message request is transmitted. The message request identifies one or more users of the system with which the sender wishes to communicate. The message request may be a group messaging session or to a single individual. In some implementations, the message may be a blind-carbon-copy message whereby the message is transmitted to several users neither of which knows the other received the message. This can be helpful when soliciting advice on a repair, for example. If all users can see the advice given by the first user, subsequent responders will have considered the previous response without approaching the problem from their own perspective. This can lead to a “group think” effect whereby everyone just agrees with the initial suggestion thereby reducing the possibility of a creative solution.

At block 512 a message response is received. The message response may be a point to point (e.g., 1-1) message or a group message. The message response may include a threadsite or an identifier for a threadsite. For example, if the transmitted message request includes a question, the response may include content or information identifying the location of content responsive to the question. As shown in FIG. 5, the method 500 ends at block 590. However, the messaging of blocks 510 and 512 may be repeated. This allows a conversation to occur while viewing the training content.

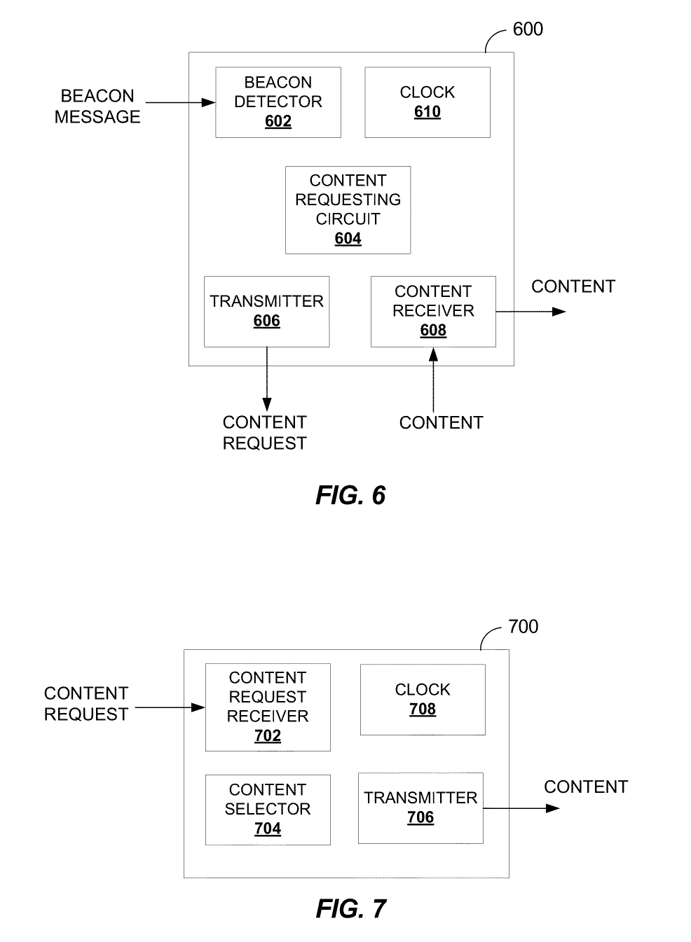

FIG. 6 shows a functional block diagram for an example of a device configured to provide training content. The device 600 may be implemented as a client device discussed above. The device 600 may implement, in whole or in part, one or more of the methods described above.

The device 600 includes a beacon detector 602. The beacon detector 602 is configured to receive a beacon message from a beacon (e.g., on-site communication device). The receipt may be via radio communications. In some implementations, the receipt may be via a scanned beacon message such as a bar code or QR code. The beacon message includes an identifier for the beacon. This allows the system to identify the beacon and where it may be installed. The identification may, in some implementations, also include a location for the beacon. This allows a common beacon to be installed on equipment which, in conjunction with location information, can uniquely identify a particular equipment installation. For example, all printers of a certain model may be equipped with a beacon transmitting the identifier “printer-1.” As there may be many printers deployed in an office, the beacon message may also include location information to identify a particular printer. The beacon detector 602 is configured to receive the beacon message at a predetermined distance from the beacon. This allows the client device to receive the beacon messages when located within the predetermined distance. This provides one non-limiting advantage of reducing the resources needed to receive the beacon messages.

The device 600 shown in FIG. 6 also includes a content requesting circuit 604. The content requesting circuit 604 is configured to generate a training content request. The training content request includes the identifier for the beacon and a user account identifier. The user account identifier may be user information or device 600 identification information. The user account identifier is preferably sufficient to uniquely identify a user or specific group of users of the device 600.

The device 600 includes a transmitter 606. The transmitter 606 is configured to transmit the training content request. The training content request may be transmitted via wired or wireless means. The training content request may be transmitted to a communication server or to a training content server, such as the one shown and described below in FIG. 7.

The device 600 includes a content receiver 608. The content receiver 608 is configured to receive the training content. The training content may include one or more of text, audio, video, multimedia, executable, tags, threadsites, or application triggering information. The content receiver 608 is further configured to initiate display of the training content. The display may include audio playback via a speaker (not shown), video display via a display device (e.g., monitor, touchscreen, LCD display) (not shown), or initiation of an application (e.g., a threadsite application).

The device 600 includes a clock 610. The clock 610 is operable at least while the training content is displayed. In some implementations, the clock 610 is configured to start timing upon receipt of the training content. This marks the beginning of the display of the training materials. This allows the device 600 to track how much training is performed for a particular content item. The clock 610 is also configured to stop timing. The timing may be stopped when the device 600 transmits a second training content request or receives a response thereto. This indicates that the user has stopped working with the provided training content. The timing may be stopped when the display of the training content stops. The termination of display may be detected based on the closing of an application triggered by the training content, stopping of the playback of the content, or the like.

In some implementations, the device 600 may include a training status transmitter (not shown). The training status transmitter may be configured to transmit an identifier for location within the training content displayed via the device. The location may identify a page, a point in time, a module, or other information that indicates how far into the training material the user worked. The training status can be used to track progress and identify subsequent content to be provided to the user.

FIG. 7 shows a functional block diagram for an example device for providing training content. The device 700 may be a training content server. In some implementations, the device 700 may be included in the communication server 102. The device 700 may implement in whole or in part, one or more of the methods described above.

The device 700 includes a content requesting circuit. The content requesting circuit is configured to receive a training content request. The training content request includes an identifier for a beacon and a user account identifier. The training content request may be received from the device 600 shown and described in reference to FIG. 6. The identifier indicates a physical item to receive training for.

The device 700 includes a content selector 704. The content selector 704 is configured to identify a training status for a user identified by the user account identifier. The training status may be identified based on training status report information stored in a database such as the database 104. The content selector 704 is configured to determine training content for the user based on the training status and the identifier. For example, the identifier may indicate equipment to be repaired and the training status of the user may indicate that the user has completed a comprehensive course on the equipment. As such, a basic reminder guide may be provided to the user. Conversely, if the training status of the user indicates the user is a newly hired agent, a more complete and comprehensive training manual may be provided for the equipment. In some implementations, the training content may prompt the agent to defer work until completing the appropriate training or certification processes.

The device 700 includes a transmitter 706 configured to transmit the training content. The device 700 also includes a clock 708. The clock 708 is operable at least upon transmission of the training content. For example, the clock 708 may be configured to start timing for the user upon transmission of the training content. The clock 708 may be configured to stop timing for the user upon receipt a second training content request or transmission of a response thereto.

The training status may indicate locations for training content provided to the user. The location may identify a page, a point in time, a module, or other information that indicates how far into the training material the user worked.

Some implementations of the device 700 may include a training status receiver (not shown). The training status receiver may be configured to receive an identifier for a location within the training content displayed to the user. The training status receiver may also be configured to update the training status of the user of the training content. In some implementations, the training status may be further updated based on the timing information maintained by the clock 708.

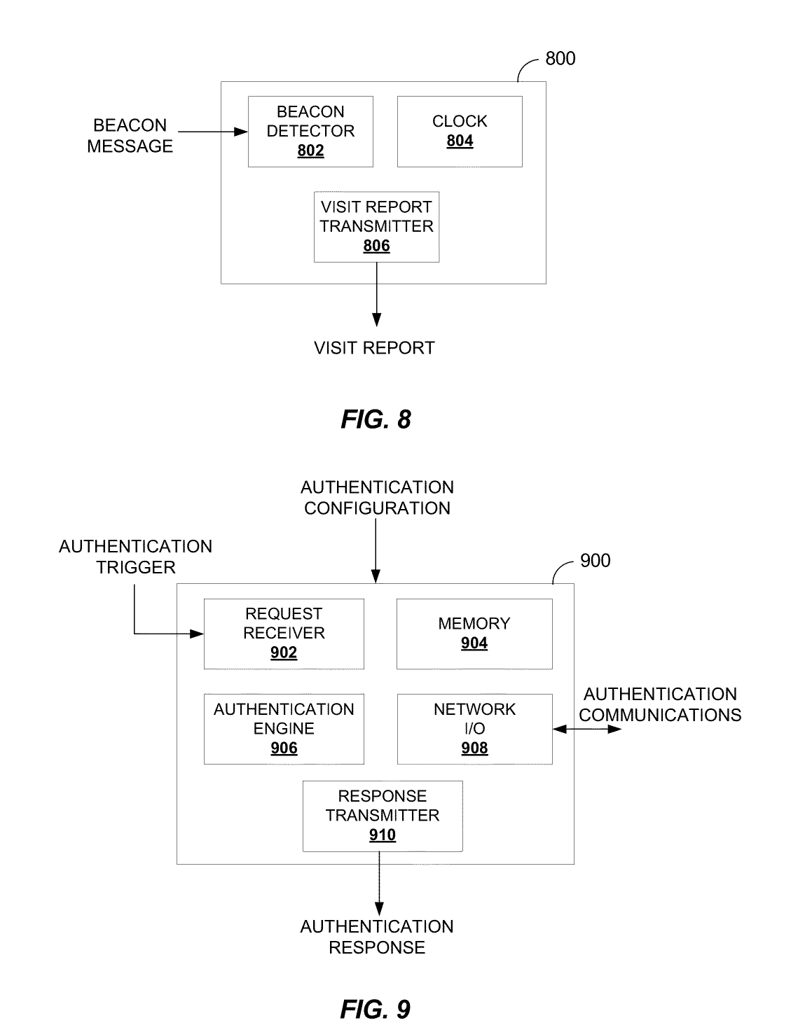

FIG. 8 shows a functional block diagram of a visit tracking device. The visit tracking device 800 may be implemented as a client device discussed above. The visit tracking device 800 may implement, in whole or in part, one or more of the methods described above.

The visit tracking device 800 includes a beacon detector 802. The beacon detector 802 is configured to receive beacon messages from a beacon (not shown). The beacon messages include an identifier for the beacon. The beacon messages are received at a predetermined distance from the beacon.

The visit tracking device 800 includes a clock 804. The clock 804 is configured to accumulate time while receiving beacon messages. The clock 804 is configured to stop accumulating time when beacon messages are no longer received. This configuration of the clock 804 tracks how long the visit tracking device 800 was within the predetermined distance from the beacon. This information can be a proxy for determining how long the visit tracking device 800 was at or near the beacon. In repair implementations, this provides a reliable indication of who visited a repair site and how long the repair site was visited.

The visit tracking device 800 includes a visit report transmitter 806. The visit report transmitter 806 is configured to transmit a visit report which includes the accumulated time, the beacon identifier, and an identifier for the visit tracking device 800.

In some implementations, features of the visit tracking device 800 and the device 600 for providing training content and training information can be commonly implemented. Such a configuration provides a comprehensive overview of the maintenance, repair, or overhaul efforts for a given installation or by a particular user. This can provide one non-limiting advantage of effectively identifying the training content which reduces visit time both in aggregate (e.g., total amount of time spent at a given site or at a given equipment model) and per visit (e.g., what content helped keep time on site for a given visit short and thus provide effective resolution to the issue). In such implementations, the clock included in the respective devices can be shared and configured to maintain multiple timers. Similarly, the beacon detector may be configured to trigger content requesting and visit reporting.

FIG. 9 shows a functional block diagram of an exemplary authentication device. The authentication device 900 may be included in a client device, the device 600, or the visit tracking device 800. In some implementations, the authentication may be performed at an authentication server, such as the authentication server 150. In such implementations, the authentication server 150 may include the authentication device 900. The authentication device 900 may be implemented as an attachable device which can connect to and be physically attached to a client device. One example is a sleeve which can receive the client device and couple therewith. In some implementations the coupled authentication device 900 may be configured to draw power from the client device it has coupled with. The data coupling may be via a wired or wireless communication protocol.

The authentication device 900 provides a configurable component that can be easily included in tagged proximity training content and time tracking systems to ensure the client devices accessing the system are given the appropriate access both to the system and the content included therein. The authentication device 900 may further provide a non-limiting advantage of providing a verifiable record of which device and user were present at a particular beacon location.

The authentication device 900 of FIG. 9 includes a request receiver 902. The request receiver 902 is configured to receive authentication triggers. An authentication trigger may be an express request for authentication. For example, an authentication request message may be provided which conforms to a predetermined format. When the request receiver 902 detects such a message, the request receiver 902 may be configured to provide the message for further authentication processing by the authentication device 900. The detection may be based on a value included in the message such as a message type identifier value. In such implementations, when the request receiver 902 receives a message including the message type identifier value identifying an authentication request, the request receiver 902 may provide all or a portion of the message for further authentication processing by the authentication device 900.

In some implementations, the authentication trigger may be receipt of a beacon message. The beacon message may not expressly require authentication, but the client device may be configured to authenticate when in proximity of a beacon. In some implementations, specific beacon messages may cause authentication. For example, beacon messages may include a value identifying the beacon message as a training or timing related beacon. This allows the selective performance of the authentication. By dynamically deciding when to authenticate, the client device can conserve resources (e.g., time, power, memory) by authenticating only for those beacon messages which are identified as requiring the authentication.

In some implementations, the authentication trigger may be location based. In such implementations, the request receiver 902 may be configured to receive location information such as geographic coordinates. The authentication device 900 may receive an authentication configuration including an authentication zone. The authentication zone may identify a location for which authentication is to be performed. When the request receiver 902 detects the entry into an authentication zone, the authentication device 900 may continue the authentication process.

An authentication engine 906 is included in the authentication device 900. The authentication engine 906 is configured to coordinate the authentication process. The coordination includes identifying what kind of authentication to perform, managing the local or remote communications to perform the authentication, and generating an authentication response. The authentication engine 906 may identify the type of authentication to perform based on the authentication trigger. For example, when the authentication trigger is a message, the message may include a value identifying the form of authentication to perform.

The types of authentication may include local authentication. To perform a local authentication, the authentication engine 906 may retrieve a value from a memory 904. If the value is present or matches a value such as one included in the authentication trigger message or authentication configuration for the authentication trigger, authentication is successful. The local authentication may be key based whereby the memory 904 stores encrypted key information to authenticate the user of the device. The key information may be loaded into memory 904 when the user logs into the client device. Accordingly, the client device may maintain the key information for the currently logged in user for authentication. It will be appreciated that the local authentication may be desirable to provide an efficient and fast authentication.

In some implementations, the authentication type may be an interactive authentication. In interactive authentication, the authentication engine 906 may cause display of a prompt for receiving a user input and receive values for the input such as user name, password, biometrics, voice, or gesture. The received values may be compared by the authentication engine 906 with stored values in the memory 906. In some implementations, the authentication engine 906 may transmit the values via a network input/output interface 908 for authentication via a remote server. This allows dynamic addition and removal of authentication privileges from a centralized location.

In some implementations, the authentication type may be a remote authentication. A remote authentication may be desirable to ensure all authentication decisions are made from a centralized facility. In such implementations, the authentication engine 906 may collect the authentication trigger, authentication information such as information stored in the memory 904 or other device information such as the location of the client device. The authentication engine 906 may then generate an authentication request for transmission to an authentication server (or another authentication device) via the network input/output interface 908. The network input/output interface 908 may receive a response which is then provided to the authentication engine 906 for further processing. As the authentication engine 906 may be managing multiple authentication triggers at once, each authentication request may include a value identifying the authentication request and allows incoming responses to be associated with the appropriate authentication request. In some implementations, the authentication server may provide an acknowledgment of receipt of the authorization request which includes the identifier. In such implementations, the initial request may not include an identifier.

Irrespective of the type of authentication performed, the authentication engine 906 ultimately arrives at an authentication determination. The determination may be binary (e.g., allowed or denied). In some implementations, the determination may be group or role based. For example, the authentication response may confirm the identity of a user and include the groups or roles assigned to the identified user. The authentication response may include a token. The token may be used for subsequent communications to indicate the authentication result. The token may be represented as a string of characters. The authentication engine 906 may generate an authentication message for transmission via a response transmitter 910. It will be appreciated that the authentication response message may be transmitted to multiple destinations such as the client device and the beacon. In some implementations, the response transmitter 910 may transmit the authentication response via the network input/output interface 908 such as when a destination is a networked device.

### Tagging Communications Systems and Methods

To facilitate the proximity training features described, a communication network system including tagging and threadsites may be implemented. The following figures describe aspects of tagging, conversations, threadsites, and transactions. While the description may reference customers and merchants, it will be understood that the features described are applicable to agent and employer relationships.

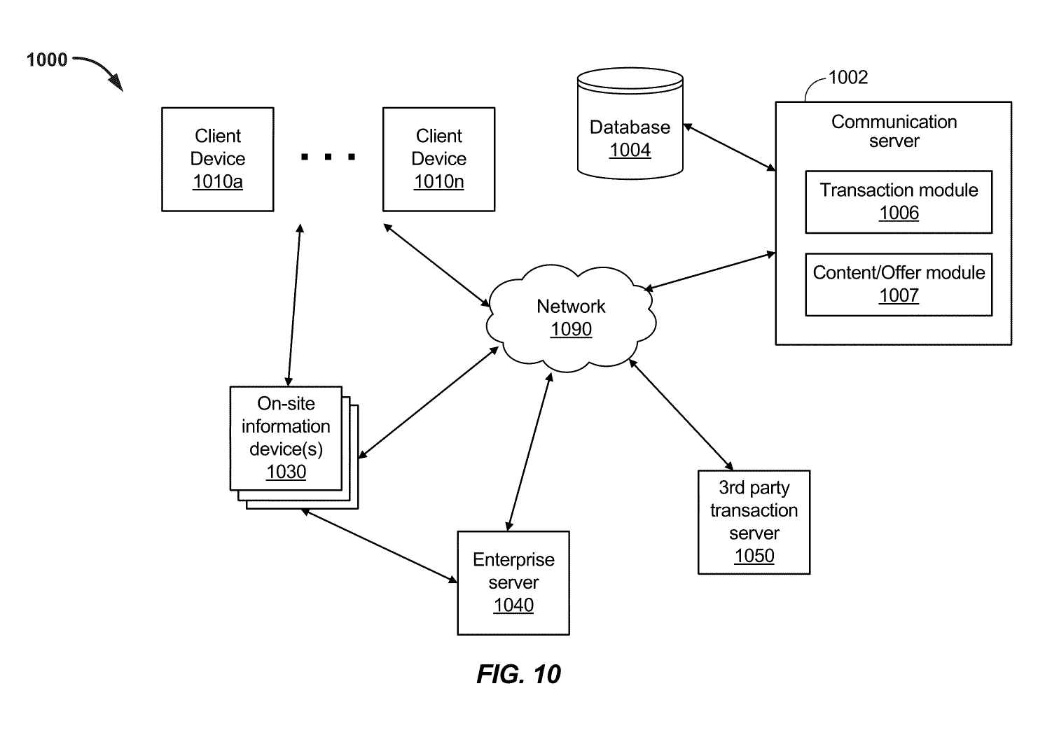

FIG. 10 is a functional block diagram of an exemplary communications network system in accordance with one embodiment. The system 100 may be implemented via a client-server architecture where a client device has an application running locally that performs a set of functions that require communication with a server in order to support desired functionality. The client application may be configured to allow users to input their desired request of the application, after which the request is sent to the server for processing. The server may be configured to optionally archive some information (e.g., tags, user contacts information, conversation archives, offers, transaction information, etc.), and the request may be routed either back to the initiating user and/or to a target user device. The system 1000 shown includes multiple client devices (e.g., a client device 1010a and a client device 1010n). It will be appreciated that fewer or more client devices may be included in the system 1000. The client device 1010a and the client device 1010n (collectively or individually hereinafter referred to as “client device 1010”) may be an electronic communication device configured to transmit and receive conversation items in a conversation thread. Examples of such electronic communication devices include smartphones, feature phones, laptop computers, desktop computers, tablet computers, personal digital assistants, set-top devices, gaming consoles, automotive dashboard systems, kiosks, self-service consoles, and the like.

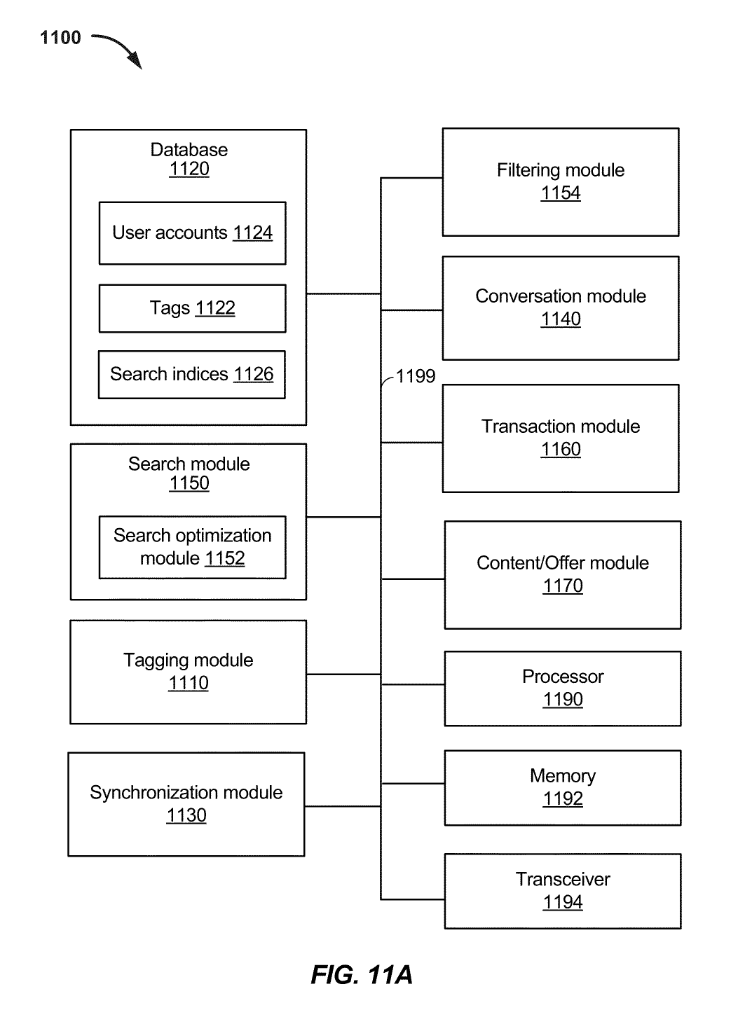

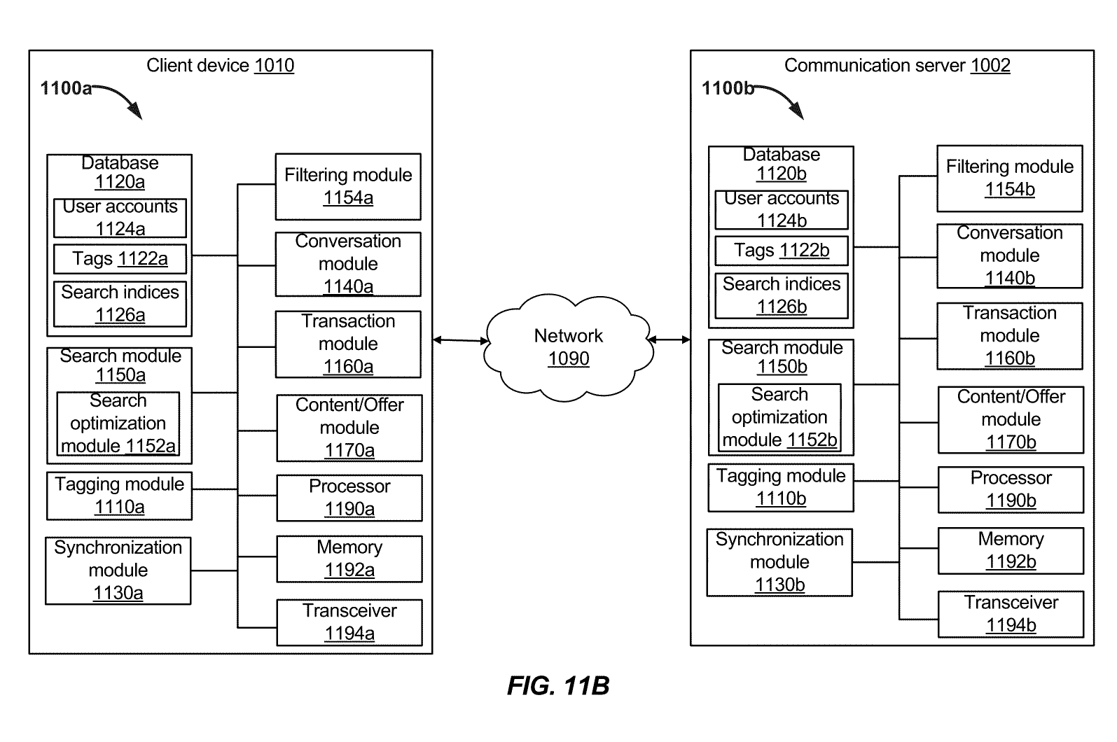

The messages the client device 1010 may be configured to transmit and receive may include the tagging and conversation items described herein. The client device 1010 may include specialized circuitry configured to transmit, receive, generate, and process the messages discussed in further detail below. In some implementations, the client device 1010 may include a processor which is configured to execute stored instructions which cause the client device 1010 to transmit, receive, generate, and process the messages described. The client device 1010 may include additional modules as described in connection with FIGS. 11A-11B below.

The system 1000 includes a network 1090. The client device 1010 may be configured to transmit and receive messages via the network 1090. Examples of the network 1090 include a wide area network (WAN), metropolitan area network (MAN), local area network (LAN), wireless local area network (WLAN), or personal area network (PAN). Although shown as one network, the network 1090 may include several interconnected networks. The networks which may be included in the system 1000 may differ according to the switching and/or routing technique used to interconnect the various network nodes and devices (e.g., circuit switching vs. packet switching), the type of physical media employed for transmission (e.g., wired vs. wireless), and the communication protocols used (e.g., Internet protocol suite, SONET (Synchronous Optical Networking), Ethernet, etc.). Regardless of the form the network 1090 may take, the network 1090 is configured to facilitate machine-to-machine messaging for tagging and communication as described herein.

The system 1000 includes on-site information device(s) 1030. An on-site information device may be an electronic communication device configured to transmit messages at a location. For example, an on-site information device may be implemented as a beacon. The beacon may be configured to transmit and receive tagging and communication messages to the client device 1010 within, for example, a store. This allows a store owner to configure messages for broadcasting to the client device upon entry into a predetermined area. Sites may include stores, amusement parks, cruise ships, restaurant, hotels, convention centers, arcades, campuses, hospitals, and casinos. The beacon may be implemented as disclosed in the Beacon Examples.

The on-site information device(s) 1030 may communicate directly with the client device 1010. In some implementations, the on-site information device(s) may communication with the client device 1010 via the network 1090.

The on-site information device(s) 1030 may be configured by a site operator. As shown in FIG. 10, the site operator may be a merchant. The system 1000 includes an enterprise server 1040. The enterprise server 1040 is configured to provide tagging and communication information. For example, the enterprise server 1040 may provide one or more tags for transmission by the on-site information device(s) 1030 at the site. The tags may facilitate the discovery of an item, location, or person at the site. The communication information may include a conversation item in a conversation thread regarding an event at the site. In a merchant implementation, the conversation item may indicate a sale on a particular item. In a hospitality implementation, the conversation item may identify the starting time for a performance. In a variety of settings, the conversation item may be used to convey emergency information such as a fire, earthquake, or other time and location sensitive event information.

The enterprise server 1040 may communicate directly with the on-site information devices 1030. In some implementations, it may be desirable to have a centrally located enterprise server 1040 and transmit the tagging and communication information via the network 1090 to on-site information device(s) 1030 located at one or more sites.

The client device 1010 may transmit and receive tags and communication information. Similarly, the enterprise server 1040 may transmit and receive tags and communication information. The tags and communication information may be processed by a communication server 1002. The communication server 1002 is configured as a hub to tagging and communication activities within the system 1000. The communication server 1002 is configured to receive tags for user accounts (e.g., the enterprise server 1040 or the client device 1010). The communication server 1002 may be configured to process the received tags such as by verifying the associated account, validating the tag, storing the tag in a database 1004, and transmitting global tags via the network 1090. The communication server 1002 may be configured to provide searching of user accounts. The searching may be based on the tags stored in the database 1004. The database 1004 may store offer rules as described further below. The database 1004 may store contacts and conversation archives. The database 1004 may also store transaction history when a transaction module 1160 (FIG. 10) completes a transaction request. In some implementations, the database 1004 may store information in an encrypted format via encrypted communication medium. In some implementations, the database may store information for a predetermined period of time. For example, the database 1004 may store conversation archives up to 30 days and transaction history up to 7 years.

The communication server 1002 may be configured to receive conversation threads for user accounts. The conversation threads may be associated one or more tags. The conversation threads may be associated with one or more user accounts. The communication server 1002 may be configured to also receive distribution information for a given conversation thread. For example, the conversation thread may not be distributed outside a predetermined set of users. As another example, the conversation thread may have limited visibility such as only to users associated with a predetermined tag. Accordingly, when a user performs a search, the conversation thread may be provided if the tags (e.g., global and/or personal) associated with the user satisfy the distribution rules for the conversation thread. As one example, consider a merchant interested in providing a promotion for a new product. The merchant may post a conversation thread to their account with a tag “OurNewCoolThing”. If a customer having a user account which is not associated with the tag “OurNewCoolThing” searches the system 1000, the new product conversation is not provided. However, if the customer adds the tag “OurNewCoolThing” to the merchant contact as a personal tag, the new product may be returned in a search by the customer.

The communication server 1002 may further manage the distribution and life of a conversation. For example, the communication server 1002 may pause or snooze an ongoing conversation. The communication server 1002 may also allow a conversation thread to be deleted. Receiving a message to delete a conversation thread may cause the communication server 1002 to ensure the user account requesting the deletion is authorized to do so and, if so, transmitting one or more messages to client devices to remove the conversation thread. This allows users a higher degree of control over conversation items.

The communication server 1002 may include a transaction processing module 1006. The transaction processing module 1006 is configured to perform payment processing or payment remittance. The transaction processing module 1006 may be configured to consummate the transaction. In some implementations, the transaction processing module 1006 may be configured to communicate with a third party transaction server 1050 to consummate the transaction. The third party transaction server 1050 may be, in some implementations, a remittance and/or payment processing server such as an e-wallet, a bank, an automated clearing house, an online money transfer service, or a digital currency exchange.

The communication server 1002 may include a content/offer module 1007. The content/offer module 1007 may be configured to provide coupons, offers, or content. The coupons, offers, or content may be provided on demand. The demand triggering the coupon or offer may be a search by a user including specific terms or having predetermined account characteristics. For example, a user account may be identified as associated with a 39 year old iguana owner located in a specific geographic area. A merchant within that area may wish to provide a coupon to lizard owners searching the system. In this example, when the iguana owner searches, the coupon from the merchant may be included in their search result. It should be understood that the coupon need not necessarily be linked to the search. However, the demand may include, for example, the search terms, stored user profile information (e.g., interests, age, home town, gender), current user information (e.g., device type, device connectivity, device operating system, GPS location information for a device), the user's tags, the user's conversations, and usage history for the user.

The demand may be based on proximity sensing via a beacon. For example, a merchant may deploy a beacon within a store. As a customer holding a wireless device (e.g., smartphone, tablet computer) enters a coverage area for the beacon, the wireless device may transmit information to the beacon. The information transmitted to the beacon may include identification information for the device, for a user of the device, and/or for an account associated with the device. The beacon may receive this information and transmit the information to the content/offer module 1007 to receive a customized offer for the user. The customization may be based on the information provided by the wireless device. In some circumstances, the user may not have previously established a personal account with the communication server 1002. In such cases, information about the device such as the media access control identifier may be used to determine characteristics of the device holder. Characteristics may include device type, device model, and device interactions (e.g., with this or other beacons). In some circumstances, the user may have previously established a personal account with the communication server 1002. In doing so, the user may have provided tags describing themselves to the world (e.g., self discovery tag). The user may also be associated with private tags assigned by the merchant (e.g., self-tagging tags). In such cases, the additional tag data may be used to further select an appropriate offer for the user.

The selection of the offer may be based on offer rules store in the database 1004. An offer rule may include one or more criteria (e.g., device characteristic, tag information, location, date, time, etc.) and an associated offer. In some implementations, a user may qualify for multiple offers. The offer rule may specify whether the associated offer may be combined with other offers, supersedes other offers, or is a default offer in the event another is selected. The offer rules may be provided by the merchant such as via a client device.

For example, a coupon code may provide content or features for download to the presenting user. The content/offer module 1007 may be configured to confirm the content or features made accessible and transmit these to the client device 1010. As another example, consider a casino implementation whereby the transaction may be a complimentary buffet dinner for users. The content/offer module 1007 may be configured to identify users who qualify for the dinner and provide a conversation thread or threadsite including an identifier for the dinner to the user. The identifier may include a code, an image (e.g., QR code or other machine readable indicator), or other identifying information for the promotion. The identifier may then be presented at the restaurant for the dinner. In some implementations, the presentation may be via the messaging application on the client device 1010. The communication server 1002 may be configure to identify a recipient for this promotion, generate an identifier for the promotional offer to the identified recipient, transmit the identifier to the restaurant or casino management system, and consummate the redemption of the offer. In some implementations, the restaurant or casino management system acting as a third party transaction server may redeem the promotion in concert with the content/offer module 1007.

The communication server 1002 may be configured to communicate with the third party transaction server 1050 via the network 1090. The communication server 1002 may include additional modules as described in connection with FIGS. 11A-11B below.

FIG. 11A is a functional block diagram of an exemplary wireless communication system in accordance with one embodiment. The electronic communication system 1100 may be implemented in whole or in part as the client device 1010 or the communication server 1002.

When implemented as the client device 1010, the elements shown may be configured to provide tagging and communication services via the client device 1010. To support tagging, a tagging module 1110 is included. The tagging module 1110 is configured to receive tags from a user such as via a user interface. The tagging module 1110 may be configured to verify the tags such as verifying that: the tag is locally or globally unique, to ensure the tag is not offensive, the tag conforms to formatting requirements (e.g., minimum length, maximum length, characters included), or that the target item (e.g., conversation or contact) can be tagged by the user.

The tagging module 1110 may be configured to communicate with a database 1120 to conduct the tag verification. The database 1120 may be implemented as in the database 1004 (FIG. 10). The database 1120 may include tags 1122. The tagging module 1110 may allow for predefined set of tags (e.g., tags 1122), may allow rules to allow tags to be acceptable by a server (e.g., the communications server 1002 in FIG. 10), and may allow for communication of the tags 1122 between the client (e.g., the client device 1010 in FIG. 10) and the database 1120. The tags 1122 are associated with one or more user accounts 1124 which may also be stored in the database 1120. The database 1120 may further include tag verification rules. The tag verification rules may be provided through a user interface on the client device 1010 to allow personal verification rules. In some implementations, the tag verification rules may be provided by the communication server 1002 to enforce system-wide tag verification.

Continuing with the client device implementation of the electronic communication system 1100, a synchronization module 1130 may be included. The synchronization module 1130 is configured to synchronize information stored on the client device 1010 with the communication server 1002. For example, the client device 1010 may be configured to operate without a network connection (e.g., “offline”). In such a configuration, the client device 1010 may receive tag information (e.g., new tags, updated tags). Similarly, while the client device 1010 is offline, the communication server 1002 may receive new tag information. The synchronization module 1130 determines which information to transmit to the communication server 1002 to synchronize the locally stored information with the centralized storage on the communication server 1002. The determination may be based on a timestamp associated with the tag information. For example, when a record is created, modified, or deleted in the database 1120, a timestamp may be applied to the record. The synchronization module 1130 may identify a point in time to synchronize with the communication server 1002 based on one or more of time, electronic communication device characteristics (e.g., power, processing bandwidth, network connectivity, temperature, memory, location), or based on a request for synchronization received from the communication server 1002. Once the point in time is identified for synchronization, the synchronization module 1130 may determine which records have been modified since the last synchronization time. These records are then transmitted to the communication server 1002.

As noted, the synchronization module 1130 may be configured to receive information from the communication server 1002. The synchronization module 1130 in receiving the information for updating is configured to reconcile the received information with the local information. For example, if a tag is updated in the database 1120 and, prior to synchronization, another user creates the tag, the synchronization module 1130 may be configured to transmit a message indicating the tag had previously been added. Alternatively, the synchronization module 1130 may be configured to simply skip any updating of the tag information since the system reflects the desired state.

The synchronization module 1130 thus far has described synchronization between a client device and a communication server. In some implementations, it may be desirable to synchronize a group of client devices. For example, if the client devices are sales associate electronic communication devices (e.g., point-of-sale tablet) at a store, it may be desirable to synchronize the tags between each associate's device. This provides a non-limiting advantage of allowing all associates to share information and enhance a customer's experience. For instance, a first associate in the shoe department may assist a customer with a new pair of Italian leather shoes. The first associate may tag the customer as interested in leather. While assisting the customer, the first associate may learn the customer is preparing for her thirtieth reunion next month. The first associate may subsequently transmit additional tags indicating the age, school, and reunion event for the customer. When the customer is seen browsing a different section of the store, say in the eveningwear department, because the tags from the first associate are synchronized onto other associates' devices, a second associate may use the previous information to direct the customer to a choice which is suited to their current interests and purchases (e.g., reunion attire for someone who graduated about 30 years ago and likes Italian leather).

The synchronization module 1130 may store synchronization rules such as the synchronization point(s) and/or which devices to synchronize with in the database 1120 or in a memory 1192. While shown in FIGS. 11A-11B as separate elements, the database 1120 may be included in a portion of the memory 1192.

The synchronization module 1130 may also be configured to coordinate conversation threads. A conversation module 1140 may be included in the electronic communication system 1100. The conversation module 1140 is configured to manage threaded conversations. The conversation module 1140 may allow conversation threads to be communicated from the client (e.g., the client device 1010 in FIG. 10) to the database 1120. The conversation module 1140 may handle client requests to create a conversation thread with a target device and respond back to the client (e.g., the client device 1010 in FIG. 10) and the target device with information related to the conversation thread that is created as a result of the client-initiated request. The target device may be another client device, for example. The conversation module 1140 may receive information for a new conversation. The new conversation information may include one or more contacts to include in the conversation. The new conversation information may include conversation content such as text, image, video, or executable instructions (e.g., application). The content may be static or streaming (e.g., real-time). The new conversation information may include distribution rules. The distribution rules allow the conversation starter to control when, where, and with whom the conversation may be conducted. For example, the initiator may lock the list of recipients. Once locked, only the recipients identified by the initiator may participate in the conversation. Participation in a conversation can include one or more of accessing the conversation content, replying to the conversation content, forwarding the conversation content, and deleting the conversation content.

Another distribution rule may be to remove a conversation. Once removed by the initial author, all copies of the conversation thread are removed from the system. For example, consider a special promotion by a sports team wherein the first one thousand responders receive a limited edition sweatband. The promotion may be published in a conversation to all users tagged as fans of the team. Once one thousand people have responded to the promotion, the conversation thread may be deleted from the system. This affords, as one non-limiting advantage, robust control over various conversation thread or threadsite campaigns.

Once a conversation is started, the conversation module 1140 may be configured to receive additional content contributed to the conversation. The additional content may be stored in the database 1120. The additional content may be presented such as via a graphical user interface. In some implementations, the conversation module 1140 may provide a conversation thread or threadsite indicating additional content has been received. For example, the conversation module 1140 may receive the promotion from the sports team and provide a summary for display on via the client device “Limited Time Promotion from Sports Team!” In some implementations, the conversation module 1140 may generate the conversation thread based on the conversation information (e.g., sender, content). In some implementations, the conversation information may include a summary for quick display.

As discussed above, a client device may operate offline. In such circumstances, conversations may be read, responded to, deleted, or started. The conversation information, like the tags, may be synchronized using the synchronization module 1130. The synchronization module 1130 may identify a point in time to synchronize with the communication server 1002 and/or other client devices as discussed above with reference to tag synchronization.

The electronic communication system 1100 may include a transaction module 1160. In a client device, the transaction module 1160 is configured to receive payment information and transmit the received information for processing or payment remittance. The payment information received by the transaction module 1160 may include username, account number, password, personal identification number, and the like.

The electronic communication system 1100 may include an offer/content module 1170. The offer/content module 1170 may be configured to receive coupons or offers. The coupons or offers may be received from the communication server 1002 or from an on-site information device 1030 (e.g., beacon). In some implementations, the coupons or offers are received on demand. The demand triggering the coupon or offer may be a search by a user including specific terms or having predetermined account characteristics as described above in reference to FIG. 10. The triggering demand may be the location of the electronic communication system 1100 (e.g., entering an area covered by a beacon). In some implementations, the offer/content module 1170 in a client device may transmit to and receive from information the offer/content module 1007 of the communication server 1002.

The electronic communication system 1100 may include a search module 1150. The search module 1150 may be optimized in a way to return efficient result sets based upon client initiated public tag search requests. When implemented in a server (e.g., the communication server 1002 in FIG. 10), the search module 1150 may have the most up to date information related to public tags and may be able to provide this up to date information. When implemented in a client device (e.g., the client device 1010 in FIG. 10), the search module 1150 is configured to receive search terms and attributes and execute a search based on the received information. The search module may be configured to identify free text, tags, categories, geography, products, events, and/or proper names included in the received information. Using the identified terms and attributes, the search module 1150 performs a search of one or more datastores. The datastores may include structured schemas (e.g., categories and directory), unstructured schemas (e.g., tagging), search index (e.g., relevance scored), and social graph analysis (e.g., relationships). The datastore may include the database 1120 at the electronic communication system 1100. In some implementations, the search module 1150 may be configured to transmit the search information via the transceiver 1194 to the communication server 1002 for searching of a central datastore.

As shown in FIG. 11A, the database 1120 includes search indices 1126. The search indices 1126 may be used by the search module 1150 to expedite searches and provide relevance information for a given search. For example, a tag may be associated with many users. As such, a search for the exact tag may associate the accounts associated with the exact match as a highly ranked result, while an account associated with a tag including the tag text may be given a lesser rank. When searching multiple datastores, the search module 1150 may be configured to aggregate the results received from each source. The ranking of the results may also be based on the source. For example, if a search result was obtained from the database 1120 on the client device, the rank may be higher than the ranking assigned to a remote source.

The search module 1150 may be configured to communicate via a predefined search service interface (not shown). This can facilitate the search module 1150 providing and consuming search services which conform to the service interface. Thus, any third party may publish the location of their search interface and allow client devices to configure these as searchable destinations. Similarly, the user may assign a ranking to each datasource to further personalize how much weight to give to a result from a particular source.

As discussed above, beacons may be deployed to transmit tags or other communications to devices which enter a predetermined area. To allow client devices to control the flow of information from beacons, a filtering module 1154 may be included in the electronic communication system 1100. The filtering module 1154 may be configured to receive beacon conversation items in a conversation thread, such as coupons or offers, and selectively process the received conversation items. The selective processing may be based on rules stored in the database 1120. A rule may identify beacons sources which the client device will receive beacon conversation items from. Beacon sources may be identified by a unique identifier associated with the entity responsible for deploying the beacon (e.g., merchant). A rule may identify communication types to receive via beacon conversation items. For example, a rule may accept offers from merchants or brands associated with specified tag information. The content of the conversation item may also be limited such as by media type included in the conversation item. This allows the client device to manage resource usage during discovery by dynamically adjusting the content it can/will handle based on available resources (e.g., power, processing, memory, bandwidth).

When the electronic communication system 1100 is implemented as either a client device of a communication server, the memory 1192 may include both read-only memory (ROM) and random access memory (RAM). The memory 1192 may provide instructions and data to a processor 1190. A portion of the memory 1192 may also include non-volatile random access memory (NVRAM).

The processor 1190 is configured to control operations of the electronic communication system 1100. The processor 1190 may also be referred to as a central processing unit (CPU). The processor 1190 may perform logical and arithmetic operations based on program instructions stored within the memory 1192. The instructions in the memory 1192 may be executable to implement aspects of the methods described herein. The elements included in the electronic communication system 1100 may be coupled by a bus 1199. The bus 1199 may be a data bus, communication bus, or other bus mechanism to enable the various components of the electronic communication system 1100 to exchange information. It will further be appreciated that while different elements have been shown, multiple features may be combined into a single element, such as bidirectional search configuration and related communications.

The electronic communication system 1100 may also include a transceiver 1194. The transceiver 1194 may include a transmitter and a receiver configured to transmit and receive data between the electronic communication system 1100 and a remote location. The transceiver 1194 may be configured for wired, wireless, or hybrid wired/wireless communication. In some implementations, the transceiver 1194 may include one or more of an antenna, a network interface controller, a signal generator, an amplifier, and a signal filter.

When the electronic communication system 1100 is implemented as the communication server 1020 (FIG. 10), the elements provide services which mirror those described in reference to the client device above. However, as the communication server 1020 provides service to many client devices, the communication server 1020 implementation of the electronic communication system 1100 is configured to control the access of the system and data to authorized users. For example, the search optimization module 1152 for the communication server 1020 may be configured to differentially optimize searches for each user. For example, the search optimization module 1152 may consider the local tags defined by a user for searches submitted by the user in addition to the global tags included in the tags 1122. Other optimizations consistent with the methods described may be included in the search optimization module such as consideration of a social graph, search indices, metadata searching, and the like. In another example, a user may initiate a public tag search, and the user request may be performed by the search module 1152 in the communication server 1002 and processed through the search optimization module 1152 in the communication server 1002 based in part on predefined system local rules as well as search rules in the communication server 1002.

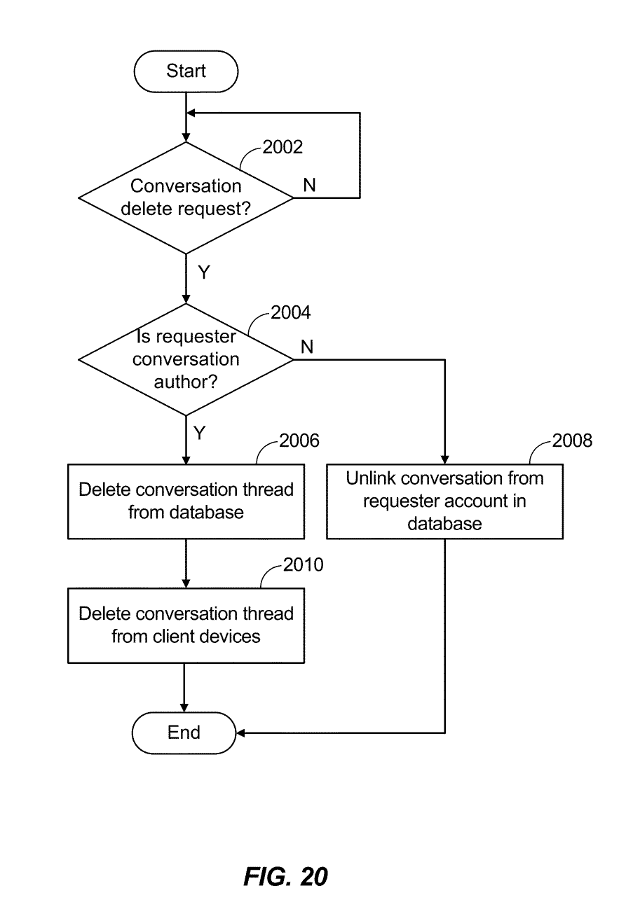

FIG. 11B is a functional block diagram of an exemplary implementation of the wireless communication system in FIG. 11A. As illustrated in FIG. 20B, the electronic communication system 1100 (FIG. 11A) may be implemented as an electronic communication system 1100a in the client device 1010 and/or as another electronic communication system 1100b in the communication server 1002. Reference to the electronic communication system 1100 (FIG. 11A) herein refers to any implementations of the electronic communication system 1100a, 1100b. The client device 1010 may be in communication with the communication server 1002 through the network 1009. Individual modules of the electronic communication systems 1100a, 1100b may further in communication with one another either within each of the electronic communication systems 1100a, 1100b through the network 1090. Reference to the modules in the electronic communication system 1100 (FIG. 11A) herein, such as the tagging module 1110, refers to any implementations of such module in either the client device 1010 or the communication server 1002, such as tagging modules 1110a, 1110b.

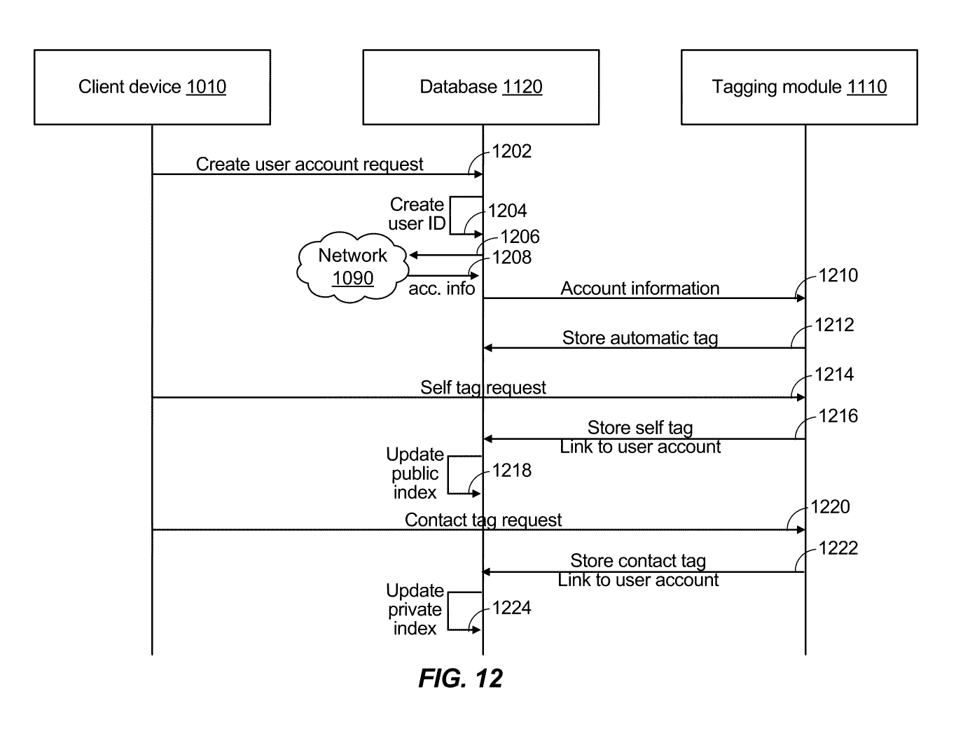

FIG. 12 is an exemplary message diagram for creating tags in accordance with one embodiment. The message flow of FIG. 12 shows messages exchanged between several entities which can be included in a communication system. For ease of explanation, the number of entities shown has been limited. However, it will be understood that additional entities can be added or multiple entities combined consistent with the description herein. In one implementation, the tagging module 1110 may be implemented in the communication server 1002 and/or the client device 1010 (FIGS. 10, 11A, 11B).

Messaging 1202 may be performed to create a new user account and can be performed by accessing the database 1120. In order to create a user account the client device 1010 may send identifying information, such as name, location, school, job title, etc., of the user's existing online accounts for social networking services (e.g., Facebook™, Twitter™, Google+™, etc.) or any other online services such as e-mail accounts, additional personal information, and new account information such as ID and password with the service provider of the communication server 1002. In one embodiment, the user may be given an option to input connection information (e.g., username, password, address) for the user's existing online accounts. In another embodiment, the user may only be given an option to create a new account with the service provider. In another embodiment, existing online account information may be automatically searched based on user-provided profile information (e.g., name, age, gender, location, school, work, name of business, place of business, industry, etc.), and the user may be prompted to link the automatically searched existing online user personal or business accounts. In response to message 1202, a new user account space may be created in the database 1120 to store further information about the user of the client device 1010. The user account may be further linked to the user's existing online account and additional information provided by the user of the client device 1010.

Messaging 1204 may be performed to create an automatic user ID specific to the new user of the service. The automatic user ID may function as a unique identifier of the user in the system 1000 and may further function as a public identifier of the user. The automatic user ID may also be the only public identifier of the user as the user may change privacy settings associated with the user account. The automatic user ID may be linked to the newly created user account in the database 1120. In one embodiment, the communication server 1002 may automatically generate and assign an internal user ID. The automatic user ID may be of random alphanumeric characters.

Messaging 1206 may be performed to access existing user information from the user's existing online accounts through the network 1090. Messaging 1206 may further involve one or more modules to search, request, or select relevant user data from the existing user in the user's existing online account information.

Messaging 1208 may be performed to gather existing user information from the user's existing online accounts through the network 1090. Messaging 1208 may further involve one or more modules to parse and organize the received existing user information to optimize storing the information in the database 1120. The new user account and ID created in response to the messages 1202 and 1204 in the database 1120 may be linked to the received existing user information.

Messaging 1210 may be performed to create automatic tags based on the user information associated with the newly created user account in the database 1120. In one embodiment, the received existing user information may be automatically forwarded from the database 1120 to the tagging module 1110 for the tagging module 1110 to generate one or more new tags. In another embodiment, the user may be prompted with pre-populated potential tags and asked to confirm creation of the pre-populated tags. Once the tagging module 1110 receives the user information, it may generate one or more tags based on the user information associated with the user account in the database 1120. The tagging module 1110 may be configured to parse user information to generate one or more new tags, and it may be further configured to determine the optimal key words or phrases so that the new tags are not redundant and yet adequately represent automatically gathered user information, for example.

Messaging 1212 may be performed to store the newly generated tags in the database 1120. In one embodiment, the newly generated tags may be linked with the user account created in response to message 1202. In another embodiment, the new tags may be further linked with one or more existing tags associated with other user accounts in the database 1120 to facilitate searching of the tags and associating of the tags with related key words or information. In one embodiment, a search index in the database 1120 may be updated reflecting the addition of the new tags and their association with the new user account.

After the user creates the new user account, the use may further make a public self tag request, and messaging 1214 may be performed to generate one or more public self tags through the tagging module 1110. The user may select and input on the client device 1010 one or more words or phrases to create public self tags, which may be self-descriptions the user would like to be associated with. The client device 1010 then may send the user inputted words or phrases and request the tagging module 1110 to create public self tags based on the words or phrases. In one embodiment, the client device 1010 may display a message to the user suggesting a better tag words or phrases. In another embodiment, the client device 1010 may display a message to the user notifying of tagging restrictions and that the tag the user intends to create is too long, spelled incorrectly, inappropriate, or offensive. In one embodiment, the user may be allowed to override the tagging restrictions, and in another embodiment, the user may be allowed to override only some of the tagging restrictions. Upon receiving the public self tag requests, the tagging module may generate one or more tags based on the user inputted words or phrases.

Messaging 1216 may be performed to store the user generated public self tags in the database 1120. The public self tags may be linked to the user's account in the database 1120 so that searching for the tags, for example, would lead to the user account.

Upon storing the public self tags and linking them to the user account, messaging 1218 may be performed to update a public search index. Reflecting various implementations of a public search, the public search index may be one of many search indices in the database 1120 and may link and organize various tags to optimize public searches. In one embodiment, a public search may be for searching the entire user accounts in the database 1120 regardless of whether the search requester has any connection with the users of the user accounts. In another embodiment a public search may be for searching the entire user accounts except the ones listed in the search requester's contacts. In another embodiment a public search may be searching the entire accessible conversation threads in the database 1120 regardless of the search requester's involvement in the conversation threads. In one embodiment, a public search may be tailored to the search requester's user account. In another embodiment, a public search may universal to all the user accounts in the database 1120.

The user may connect with other users in the system 1000 and request to add one or more private contact tags to those other users, and messaging 1220 may be performed to generate private contact tags through the tagging module 1110. The user may input through the client device 1010 one or more words or phrases to generate private contact tags, which may be associated with one or more of the user's contacts. In one embodiment, the private contact tags are user-specific, and they may reflect the user's own description of the contact only available to the user.

Messaging 1222 may be performed to store the private contact tags created by the user in the database 1120. The private contact tags may be linked to the user account to allow only the user linked to the private contact tags can view the private contact tags, for example.

Upon storing the private contact tags and linking them to the user account, messaging 1224 may be performed to update a private search index. The private search index may be one of many search indices in the database 1120. In one embodiment, the private search index may be linked to the user account in the database 1120 to allow the user's exclusive access to the private contact tags.

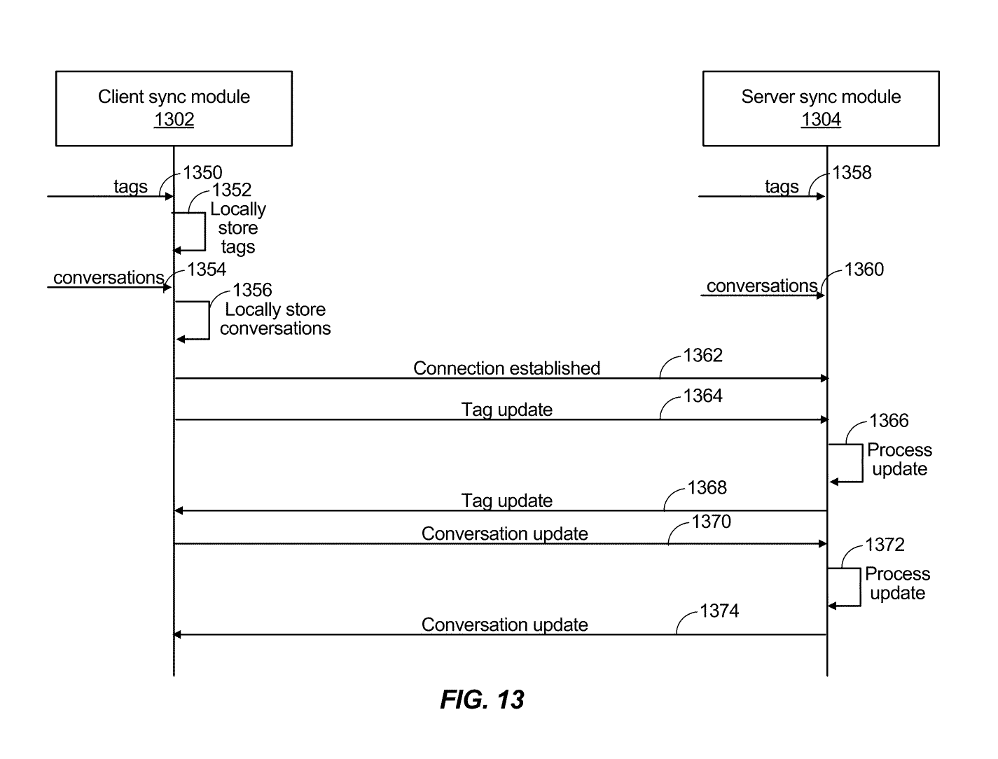

FIG. 13 shows a messaging diagram for an example synchronization session between a client device and a communication server. While the messaging diagram of FIG. 13 shows messages between a client synchronization module 1302 and a server synchronization module 1304, it will be appreciated that other intermediary elements may be included. For the sake of clarity, these intermediaries have been omitted from the discussion of FIG. 13.

The synchronization session may be used to transfer information obtained while a client device is off line. The information may be obtained at the client device or received from other users at the communication server. As such, when the client device reconnects to the network and establishes a link with the communication server, both the client and server may be configured to synchronize to ensure the real time search and discovery is maintained.

Via message 1350, the client synchronization module 1302 receives one or more tags from the client device 1010 (FIG. 10). Via message 1352, the tags are stored locally. In storing the tags locally, the client synchronization module 1302 may include information indicating that the tags have not been communicated to the server.

Similarly, via message 1354, the client synchronization module 1302 receives one or more conversations. Via message 1356, the client synchronization module 1302 locally stores the conversations. As with the tags, the conversations may be stored in association with information indicating the conversations have not been communicated to the server. As shown in FIG. 13, the server synchronization module 1304 may also receive tags and conversations via messages 1358 and 1360, respectively, while the client is disconnected.

At a point in time, the client device may connect to the communication server. Via message 1362, a connection between the client synchronization module 1302 and the server synchronization module 1304 is established. Establishing a connection may include transmitting a message identifying the client device and a user account for which synchronization is to be performed. Via message 1364, the tags to be synchronized are transmitted to the server synchronization module 1304. The server synchronization module 1304 is configured to process the updated tag information via message 1366. Processing the updated tag information may include validating the received tags, updating the database for the received tags, triggering re-indexing, triggering the rebuild of a social graph, triggering the regeneration of search metadata, or the like. The update may include adding new tag, deleting a tag, or modifying a tag for a contact, conversation, or user account.

Processing the tag update may also include reconciling the updates received from the client device with any tag information received while the client device was disconnected. The reconciliation process ensures that redundant tags are not stored, thereby conserving resources such as processing time, power, and memory. In some implementations, the server synchronization module 1304 may be configured to transmit tags to the client synchronization module 1302. For example, a contact included in the contact list at the client device may update their global tags with the server while the client device is offline. Accordingly, when the client device reconnects, the new tag information may be transmitted to the client device such as via message 1368.

A similar process is performed for conversations whereby via message 1370 conversations identified for synchronization are transmitted to the server synchronization module 1304 and processed via message 1372. Any conversations including the user of the client device which are updated while the client device was offline will be provided to the client synchronization module 1302 via message 1374.

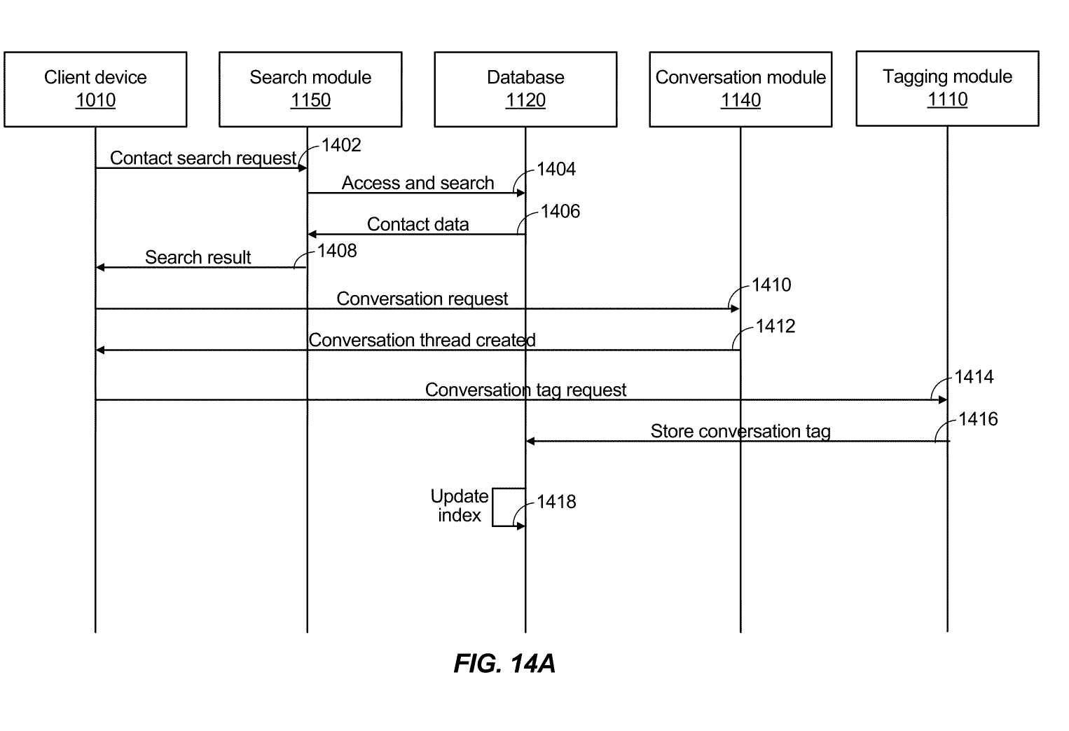

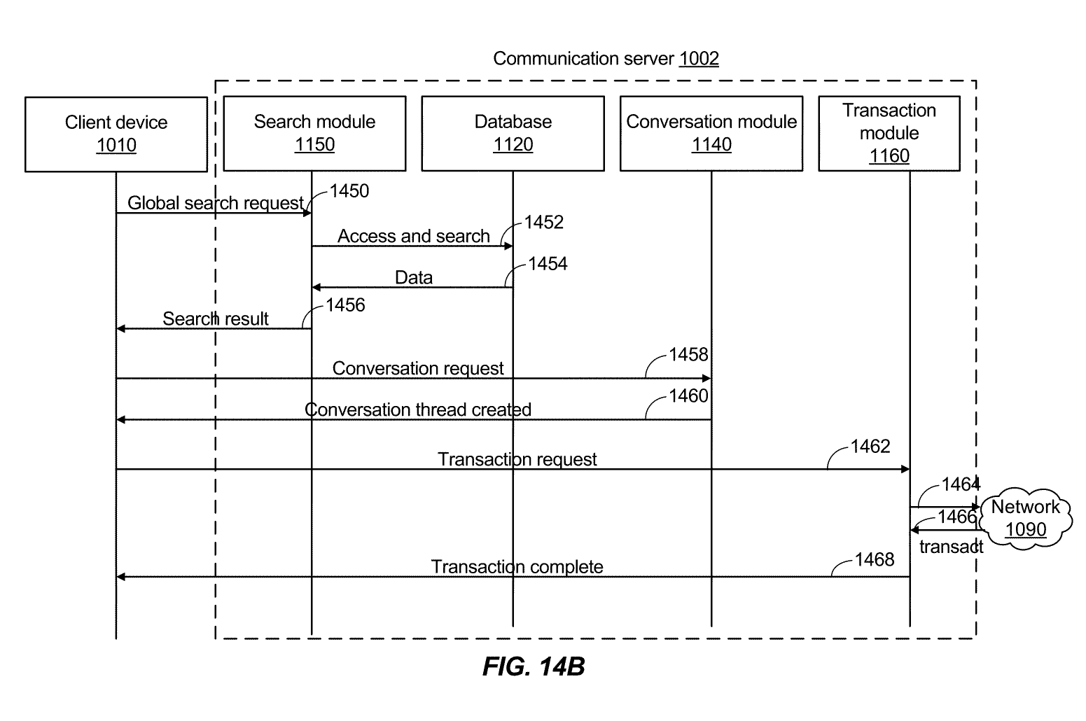

FIG. 14A is an exemplary message diagram for creating a conversation thread in accordance with one embodiment. The message flow of FIG. 14A shows messages exchanged between several entities which can be included in a communication system. For ease of explanation, the number of entities shown has been limited. However, it will be understood that additional entities can be added or multiple entities combined consistent with the description herein. In one implementation, the search module 1150, the conversation module 1140 and the tagging module 1110 may be implemented in the communication server 1002 and/or the client device 1010 (FIGS. 10, 11A, 11B).

Messaging 1402 may be performed to request a private search to be executed by the search module 1150. The client device 1010 may send search terms inputted by the user of the client device 1010. In one embodiment, the user may be prompted with options to select a subset of the user's contacts to narrow the search target. The options may be predefined (e.g., categories) or dynamically specified such a via a user input value. In one embodiment, the user may be given an option to exclude certain contacts from the private search. In another embodiment, a private search may be performed to search the user's entire contacts. In one embodiment, a private search may be performed on the user's conversation threads with one or more of the user's contacts. In another embodiment, the user may be given an option to exclude conversation threads from the private search. In one embodiment, the user may be given suggested search terms which the user may select instead of the user inputted search terms.

Messaging 1404 may be performed to access and search relevant portions of the database 1120 by the search module 1150. Once the search module 1150 receives a private search request with search terms, for example, the search module 1150 may process the search terms to optimize the private search. In one embodiment, only the private search index in the database 1120 may be searched in response to the private search request. In another embodiment, the search module 1150 may be configured to prioritize the private search index over other types of information of the user's contacts in the database 1120. In one embodiment, the search module 1150 may search the user's private tags. In another embodiment, the search module 1150 may search the user's private tags in conjunction with the user's contacts' public tags. In one embodiment, the search module 1150 may access only information on the user's contacts in the database 1120 in response to the private search request. In one embodiment, the search module 1150 may access information on the user's contacts as well as the user's conversation with any of the user's contacts in the database 1120 in response to the private search request.

Messaging 1406 may be performed to retrieve contact data from the database 1120 by the search module 1150. After the search module 1150 performs a search on relevant subsets of data in the database 1120, the search module 1150 may receive contact data as a result of the private search. The search module 1150 may further process the retrieved contact data in preparation for presenting the search result to the user of the client device 1010.

Messaging 1408 may be performed to receive and display search result by the client device 1010. In one embodiment, the search module may sort and organize the contact data it retrieved from the database 1120. In another embodiment the search module 1150 may send raw search result to the client device 1010, and the client device may sort and organize the raw search result contact data it received from the search module 1150. In one embodiment, the search result may be presented to the user based on user-defined priorities. In one embodiment, the search result may be prioritized based on relevance and/or the user's communication frequency with the contacts, for example.

Once the user is provided with a private search result, the user may select one or more of the contacts from the search result, and messaging 1410 may be performed to request to create a conversation thread by the client device 1010. In one embodiment, the user may select one or more contacts from the private search result to start a conversation thread. In one embodiment, anyone who joins the conversation thread may invite and add others. In one embodiment, the user may select to create a locked conversation thread, which may limit adding a new participant to the conversation thread by participants but may allow the conversation originator the option to add participant at any time. In one embodiment, the user may select to create a broadcast conversation thread, which only allows one-way communication from the user to other participants of the thread. In one embodiment, a broadcast conversation thread may allow participants to identify others within the broadcast. In another embodiment, a broadcast conversation thread may disallow participants from identifying others within the broadcast if the user elects to enable blind carbon copy (BCC). In one embodiment, the user may select to blind carbon copy (BCC) the conversation thread recipients so that the recipient may not be able to view other conversation participants nor their response to the user. The client device 1010 may receive from the user all the requisite and optional inputs for creating a conversation thread and may send a conversation request based on the user's inputs.

Messaging 1412 may be performed by the conversation module 1140 to create a conversation thread based on the conversation request from the user of the client device 1010. The conversation module 1140 may be configured to create a communication or conversation thread to which multiple users of the system 1000 may be added. In one embodiment, the conversation thread may also be stored in the database 1120. In one embodiment, the conversation thread may be linked to all the participants of the conversation, and in another embodiment, the conversation thread may be only linked to the conversation requester. The conversation module 1140 may be configured to allow multiple participants to send and receive instant conversation items including text, audio, video, image, other content, etc. through the conversation thread. According to the user's conversation request, the conversation module 1140 may be configured to limit the thread participant's ability to reply to the communication, view other thread participant, and/or add additional participants.

Messaging 1414 may be performed to add one or more tags to the conversation created in response to the user's conversation request. The user may input one or more words describing the conversation thread on the user device 1010, and the user device may send the conversation tag information to the tagging module 1110. In one embodiment, the conversation tag may be searchable by any user in the system 1000. In another embodiment, the conversation tag may be searchable only by the user's contacts. In another embodiment, the conversation tag may not be searchable by users other than the creator of the conversation thread. In one embodiment, the conversation tags may be public tags, which may be searchable by any user of the system. In another embodiment the conversation tags may be private tags, which may be searchable only by the tag creator. In another embodiment, the conversation tags may be either private or public and the tag creator may be given an option to choose either.

Messaging 1416 may be performed to store the conversation tags created in response to the user's conversation tag request. In one embodiment, the conversation tags may be linked to the conversation thread in the database 1120. In one embodiment, the conversation tags may also be linked to all the participants of the conversation thread, and in another embodiment, the conversation tags may only be linked to the conversation tag creator.

Messaging 1418 may be performed to update one or more indices in the database 1120 based on the newly created conversation tags. In one embodiment, the private search index may be updated to reflect a creation of the private conversation tags. In another embodiment, the public search index may be updated to reflect a creation of the public conversation tags. In another embodiment, both the private and public search indices may be updated to reflect a creation of the private and public conversation tags.

FIG. 14B is an exemplary message diagram for transacting through a conversation thread in accordance with one embodiment. The message flow of FIG. 14B shows messages exchanged between several entities which can be included in a communication system. For ease of explanation, the number of entities shown has been limited. However, it will be understood that additional entities can be added or multiple entities combined consistent with the description herein. In one implementation the search module 1150, the conversation module 1140, and the transaction module 1160 may be implemented in the communication server 1002 and/or the client device 1010 (FIGS. 10, 11A, 11B).

Messaging 1450 may be performed to request a public search to be executed by the search module 1150. The client device 1010 may be configured to send search terms inputted by the user of the client device 1010. In one embodiment, the user may be prompted with options to select a subset of the database 1120 to narrow the search target. In one embodiment, the user may be given an option to exclude the user's entire contacts from the public search, in another embodiment, the user by given an option exclude some of the user's contacts from the public search. In one embodiment, a private search may be performed to search the database 1120. In one embodiment, a public search may be performed on the public conversation threads regardless of whether the user or any one of the user's contacts is participating in the conversation. In one embodiment a public search may be performed on public conversation tags. In another embodiment, the user may be given an option to exclude conversation threads from the public search. In one embodiment, the user may be given suggested search terms which the user may select instead of the user inputted search terms.

Messaging 1452 may be performed to access and search relevant portions of the database 1120 by the search module 1150. Once the search module receives a public search request with search terms, for example, the search module 1150 may be configured to process the search terms to optimize the public search. In one embodiment, the public search index in the database 1120 may be searched in response to the public search request. In one embodiment, the search module 1150 may be configured to search other users' public tags. In another embodiment, the search module 1150 may be configured to search the user's private tags in conjunction with other users' public tags. In one embodiment, the search module 1150 may access information on other users' public profile information in the database 1120 in response to the private search request. In one embodiment, the search module 1150 may be configured to access information on other users' public profile as well as other users' conversation having public tags in the database 1120 in response to the public search request.

Messaging 1454 may be performed to retrieve public search data from the database 1120 by the search module 1150. After the search module performs a search on relevant subsets of data in the database 1120, the search module 1150 may receive data as a result of the public search. The search module may further process the retrieved public search data in preparation for presenting the search result to the user of the client device 1010.

Messaging 1456 may be performed to receive and display search result by the client device 1010 to the user. In one embodiment, the search module 1150 may be configured to sort and organize the public data it retrieved from the database 1120. In another embodiment the search module may send raw search result to the client device 1010, and the client device may sort and organize the raw search result data it received from the search module. In one embodiment, the search result may be presented to the user based on user-defined priorities. In one embodiment, the search result may be prioritized based on relevance, priority, location, and/or distance from the user, for example.

Once the user is provided with a public search result, the user may select one or more of the entries (e.g., other personal users, business users, etc.) in the search result, and messaging 1458 may be performed to request to create a conversation thread by the client device 1010. In one embodiment, the user may select one or more entries from the public search result to start a conversation thread. In one embodiment, anyone who joins the conversation thread may invite and add others. In one embodiment, the user may select to create a locked conversation thread, which may limit adding a new participant to the conversation thread. In one embodiment, the user may select to create a broadcast conversation thread, which only allows one-way communication from the user to other participants of the thread. In one embodiment, the user may select to blind carbon copy (BCC) the conversation thread recipients so that a recipient may not be able to view other conversation recipients who received the same conversation item through the conversation thread. The client device 1010 may be configured to receive from the user all the requisite and optional inputs for creating a conversation thread and may send a conversation request based on the user's inputs.

Messaging 1460 may be performed by the conversation module to create a conversation thread based on the conversation request from the user of the client device 1010. The conversation module may create a communication thread to which multiple users of the system 1000 may be added. In one embodiment, the conversation thread may also be stored in the database 1120. In one embodiment, the conversation thread may be linked to all the participants of the conversation, and in another embodiment, the conversation thread may be only linked to the conversation requester. The conversation module 1140 may be configured to allow multiple participants to send and receive instant conversation items including text, audio, video, image, other content, etc. through the conversation thread. According to the user's conversation request, the conversation module 1140 may be configured to limit the thread participant's ability to reply to the communication, view other thread participant, and/or add additional participants.

Messaging 1462 may be performed to request transaction with one of the participants of the conversation thread. As the user communicates with one or more other users through the conversation thread, the user may decide to transact with one of the participants. In one embodiment, the user may create a transaction channel associated with the conversation thread. In one embodiment, the conversation thread may have embedded transaction options for the user to choose from. In another embodiment, a transaction channel may have been created when the conversation was tagged by the user or other participants as a transactional thread. In one embodiment, the user may be prompted to add the amount of money to be exchanged and the method of exchanging money. In another embodiment, the transactional information (e.g., amount of money, method of payment, etc.) may be prepopulated based on the conversation among the participants in the conversation thread and/or one or more conversation threads. In one embodiment, the user may be prompted to edit transaction information and/or add additional information (e.g., place to meet, delivery method, return or exchange policy information, customer service, information, promotional information, discounts, etc.) in connection with the transaction.

Messaging 1464 may be performed to send transactional information to the network 1090 to consummate the transaction requested by the user of the client device 1010. Once the transaction module 1160 receives and processes the transaction information provided by the user, the transaction module 1160 may be configured to forward that information to a different server (e.g., the third party transaction server 1050 in FIG. 10) through the network 1090. In one embodiment, a single transaction may involve more than one transaction servers and may involve more than one of messages similar to message 1464.

Messaging 1466 may be performed to report back to the transaction module 1160 to indicate whether the transaction requested by the user of the client device 1010 was successful. In one embodiment, the third party transaction server 1050 may be configured to send a confirmation code or a receipt number upon completion of the transaction. In one embodiment, more than one server may be involved in the transaction, and there may be more than one messages such as message 1466 to consummate the transaction. In one embodiment, the transaction module 1160 may be configured to receive a transaction unsuccessful message through the network 1090, and there may be one or more following messages between the transaction module 1160, client device 1010, and/or third party servers 1050 (FIG. 10) to complete a successful transaction. In one embodiment, the transaction may not need a third party server, and the entirety of the transaction may be consummated within the communication server 1002 (FIG. 10) without messages 1464 and 1466. In one embodiment, the transaction module 1160 implemented in the client device 1010 (FIG. 10) may transmit a transaction request to a server by means of the network 1090 for processing without requiring that a response (successful or unsuccessful) being received by the transaction module 1160 implemented in the client device 1010 (FIG. 10) from the network 1090 in order to finalize the transaction.

Messaging 1468 may be performed to send a transaction complete report to the client device 1010 in response to the transaction request of the user of the client device 1010. Upon completion of a successful transaction, the transaction module 1160 may have obtained a confirmation code or a receipt number of the completed transaction. The transaction module 1160 may forward that information to the client device 1010 for further reference for the user of the client device 1010. The transaction module 1160 may also send to the client device a message confirming the additional information exchanged between the conversation participants associate with the transaction, such as place to meet, delivery method, return or exchange policy information, customer service, information, promotional information, discounts, etc. Upon receiving the transaction complete message, the client device 1010 may further prompt the user to set up an appointment or a reminder for the user based on the additional transaction information (e.g., delivery estimate date reminder, time and place to meet, promotion expiration date reminder, return or exchange expiration date reminder, etc.).

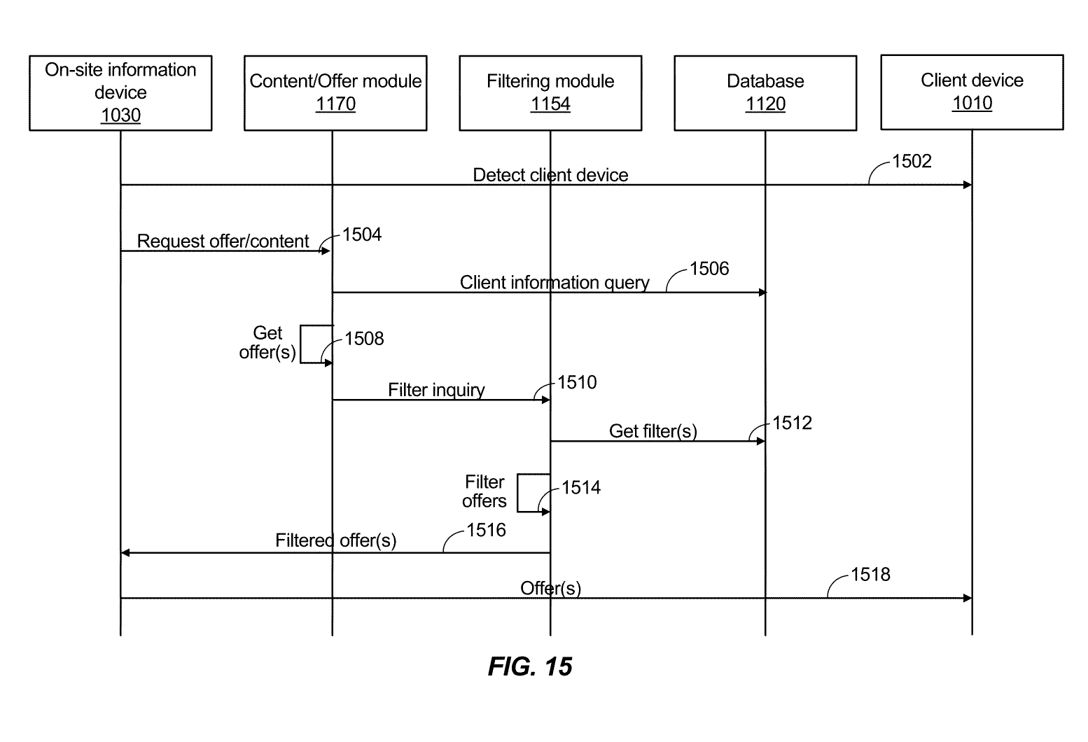

FIG. 15 is an exemplary message diagram for receiving and filtering promotional information in accordance with one embodiment. The message flow of FIG. 15 shows messages exchanged between several entities which can be included in a communication system. For ease of explanation, the number of entities shown has been limited. However, it will be understood that additional entities can be added or multiple entities combined consistent with the description herein.

Messaging 1502 may be performed to detect a presence of the client device 1010 by one of the on-site information device(s) 1030. The on-site information device 1030 may be a beacon configured to detect the client device presence through IEEE 802.15.1 compliant wireless radio technology (e.g., Bluetooth), Wi-Fi, or other wireless technology. The on-site information device 1030, for example may detect the presence of the client device 1010 through Wi-Fi and receive the MAC address of the client device 1010 for further a processing of the user data in conjunction with the user profile data already available in the database 1120. In the implementation using the Wi-Fi technology may allow the system 1000 long-term tracking of the user activities and behavior by identifying the user of the client device 1010 through the on-site information device(s) 1030.

Messaging 1504 may be performed to request promotional information to eventually send to the user of the client device 1010 from the on-site information device 1030 upon the detection of the client device 1010. Message 1504 may include information about the client device 1010, such as the MAC address of the device, as detected by the on-site information device 1030, such as a beacon. Message 1504 may also include information about the beacon itself, such as the location of the beacon and associated merchant of the beacon.

Messaging 1506 may be performed to access the user account in the database 1120 by the content/offer module 1170 in response to the receipt of the promotional information request. The content/offer module 1170 may be configured to request to obtain, for example, user preferences, account information, tags, or filters linked to the user account to determine whether and what kind of promotional information the user would like to receive. In response to the client information query, the client/offer module 1170 may receive the requested client information. As discussed above, the client device 1010 may not be associated with an account within the system. However, the device attributes may be identifiable and included in the client information. Even the absence of information for a client device can have meaning to a merchant such as to indicate this is the first time this customer device is in their store. This type of information can help tailor the interaction with this client device, at this merchant location, at this point in time.

Messaging 1508 may be performed to generate promotional information, such as offers, by the content/offer module 1170 once the content/offer module 1170 receives client information, if any. In one embodiment, the promotional information may be generated by an internal or external targeting engine that processes user profile information, user-created tags, user activities, and other user-specific data accessible through the client information query from the database 1120. In one embodiment, promotional information may consist of location-specific promotional information, such as a coupon relevant to one section of a mall. Promotional information may consist of time-specific promotional information, such as a coupon that would expire in an hour.

Messaging 1510 may be performed to determine if the content/offer should be further filtered according to the filters or other preferences set by the user of the client device 1010. Message 1510 may include information on or the nature of the offer(s) generated by the content/offer module 1170 and the client identifying information, such as client account information, and client device information, such as the MAC address.

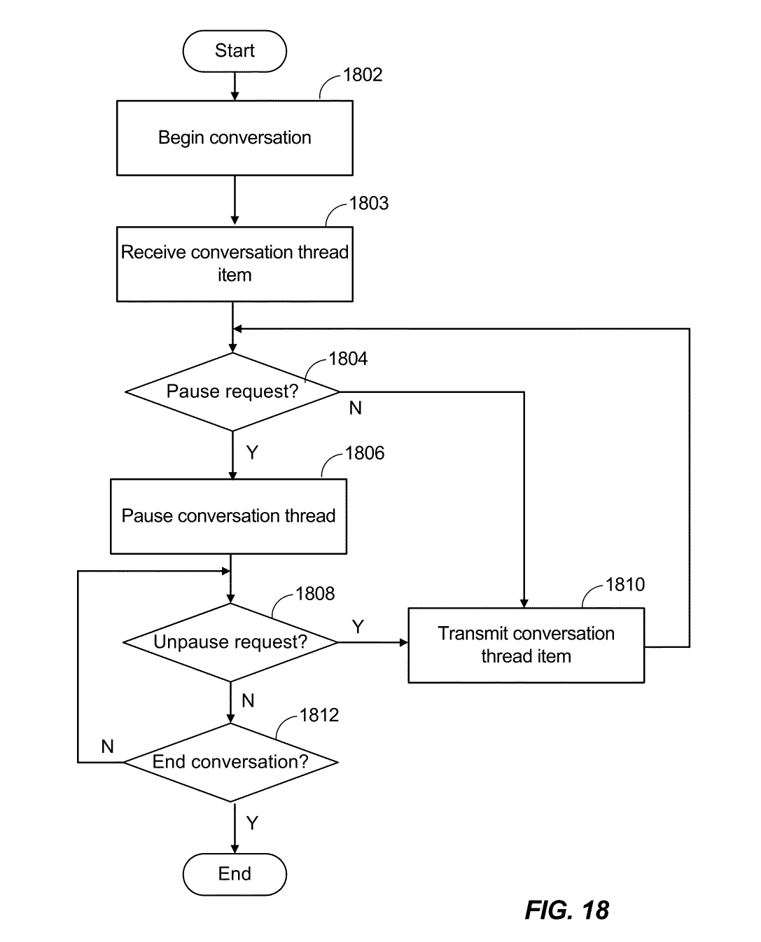

Messaging 1512 may be performed to request filtering based on the filters stored and linked to the user account in the database 1120. A filter parameter may be based on one or more public or private tags described in connection with FIGS. 12, 14A, and 14B. A filter parameter may also be based on the user's managing (e.g., pausing, snoozing, or deleting) a conversation thread described in connection with FIGS. 18-20 below. In one embodiment, the user may have an option to create a filter (not shown) and be asked to enter filtering parameters, and the client device 1010 may send the filtering parameters along with the request. In one embodiment, a filter request may be pre-populated and be confirmed by the user based on the user's public or private tags and conversation thread management. In one embodiment, a filter may be automatically generated based on the user's public or private tags and conversation thread management. In one embodiment, a filter may be an entity internal to the search module 1150 and/or the search optimization module 1152 not viewable to the user. In another embodiment, a filter may be an entity viewable and alterable by the user. In another embodiment, some filters but not others may be viewable and alterable by the user. Once the client's filters are determined, further messaging may be performed to store the filter requested by the user of the client device 1010. In one embodiment, the filter may be stored in the form of a tag. In one embodiment, the filter may be stored in the form of a conversation thread management (e.g., pausing, snoozing, or deleting, described in connection with FIGS. 18-20 below). In one embodiment, the filter may be created separate from tags or conversation thread management but may still be based on tags or conversation thread management. In one embodiment, the filter may be created based on user inputted filtering parameters at the time of the user's filter request. Upon receiving the filter request and creating the filter, the filtering module 1154 may store the filter in the database 1120 and link the filter to the user account.

Messaging 1514 may be performed to filter promotional information by the filtering module 1154 once the user's existing filters in the database 1120 are determined and a filtering query is sent to the filtering module 1154. In one embodiment, filtering may be based on the tags or conversation thread management (e.g., pausing, snoozing, or deleting, described in connection with FIGS. 18-20 below). In one embodiment, filtering may be based on separate user-specified filtering parameters. Based on the user's filters and the promotional information it received from message 1510, the filtering module 1154 may be configured to determine whether the promotional information should be presented to the user as is, presented with some information blocked, or not presented at all.

Messaging 1516 may be performed to send filtered promotional information to the on-site information device 1030. After the filtering module 1154 processes the promotional information data based on the user's filters, the filtered promotional information may be sent to the on-site information device 1030 to be eventually presented to the user of the device 1010. For example, if the user's filters indicate that the user is not interested in purchasing clothes and the promotional information is exclusively related to clothes sales, the promotional information may not be displayed at all. In another example, if the user's filters indicate that the user is interested in buying only a new car and the promotional information contains both new and old car sales information, the promotional information may be filtered to display only new car sales information. In another example, if the user's filters through the conversation thread management indicate that the user does not want to be disturbed by promotional information, the promotional information may not be presented to the user of the client device 1010.

Messaging 1518 may be performed to provide offers to the client device 1010. In one embodiment, the transmission of promotional information may be in the form of a conversation thread. In such an example, the promotional information may be a publicly tagged conversation thread, which may be searchable by the users of the system 1000. In one embodiment, the transmission of promotional information may be in the form of a locked conversation thread privately tagged by the merchant, established only between the user of the client device 1010 and the merchant. In another embodiment, the transmission of promotional information may be in the form of a sponsored conversation item or thread or advertisement distinct from a conversation thread. In one embodiment, the transmission of the promotional information may trigger a prompt to the user of the client device whether to accept or rejection to receive the promotional information. In one embodiment, the transmission of the promotional information may require the client device 1010 to determine whether any prompt to the user may be displayed. The client device 1010 may be configured to make such determination based on the account information of the user of the client device 1010.

One non-limiting advantage of the system is bidirectionally tailored communication between merchants and customers. Through on-site information devices such as beacons in conjunction with the communication system, such as tagging, disclosed herein, merchants may easily gather, track, and process customer data to tailor promotional information to individual customers. On the other hand, through tagging and conversation thread management, customers may influence and manage how the tailored promotional information is presented to them through the highly-personalized communication platform disclosed herein.

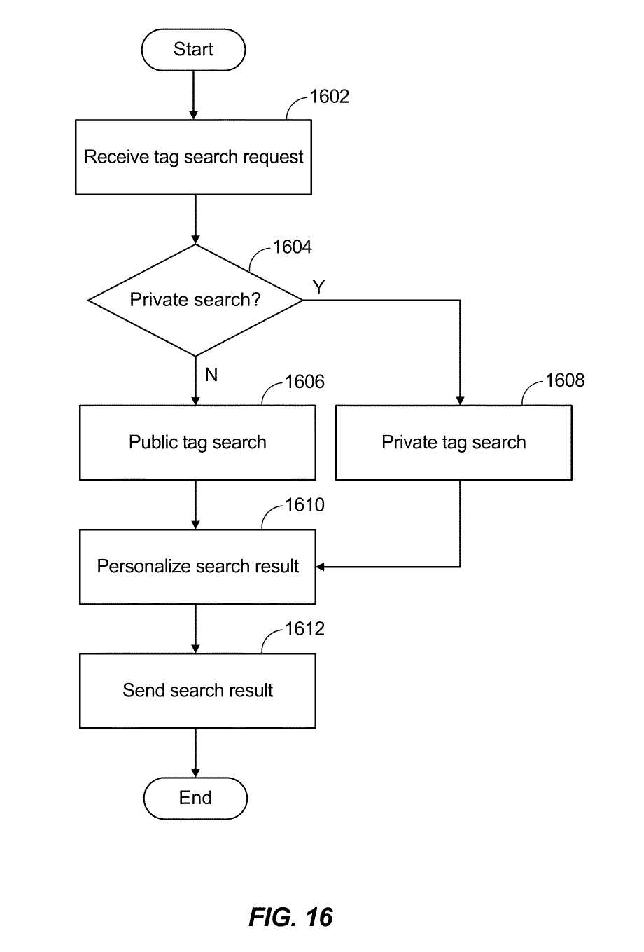

FIG. 16 is a flowchart for an exemplary method of searching tags in accordance with one embodiment. The method shown in FIG. 16 may be implemented in the search module 1150 that is in communication with the database 1120 in the communication server 1002 as described in connection with FIGS. 10, 14A, and 14B.

At block 1602, a search request may be received. In one embodiment, the search module 1150, upon receipt of the search request, may be configured to process the search request which includes the search terms to facilitate an accurate search. The processing of the search request may include identifying free text, tags, categories, geography, products, events, and/or proper names included in the received information. The processing may further include identification of the data sources for the search. After the search request is received, the process may continue to decision block 1604.

At decision block 1604, a determination is made as to the search request is a private search request or a public search request. If the search request is a public search request, the process continues to block 1606. If the search request is a private search request, the process may continue to block 1608.

At block 1606, a public tag search may be performed. In one embodiment, the public index in the database 1120 may searched to perform the public tag search. After the public tag search is performed, the process may continue to block 1608.

At block 1608, a private tag search may be performed. In one embodiment, the private index in the database 1120 may be searched to perform the private tag search. After the private tag search is performed, the process may continue to block 1610.

At block 1610, the search result set may be personalized. Personalization may include reordering the search result sets based on user-defined parameters. For example, the user may provide a data source preference list which identifies a ranking of results from each data source. In such an example, a result from a higher ranked data source may be listed more prominently (e.g., nearer to the first presentation position on the result list) than other results. In one embodiment, the search result may be reordered based on the prioritization derived from the user's general profile. After the search result is personalized, the process may continue to block 1612.

At block 1612, the search result set may be sent to the requester's device. After the search result set is sent to the requester's device, the process ends.

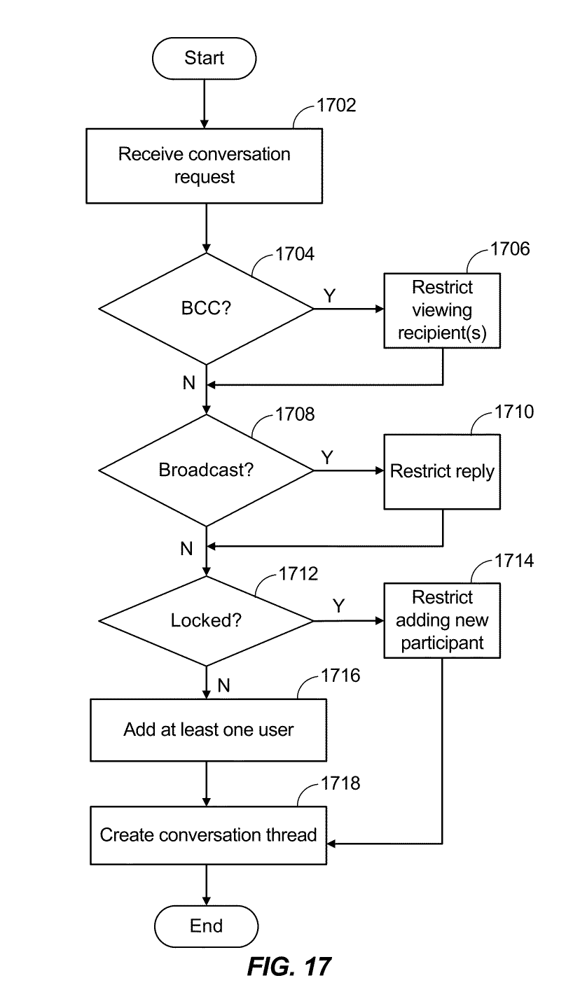

FIG. 17 is a flowchart for an exemplary method of creating a conversation thread in accordance with one embodiment. The method shown in FIG. 17 may be implemented in the conversation module 1140 in the communication server 1002 as described in connection with FIGS. 10, 11A, 11B, 14A, and 14B.

At block 1702, a conversation request may be received. The conversation request may include a conversation type (e.g., BCC, group conversation, etc.) and one or more participants. In one embodiment, the conversation module 1140 may receive additional conversation restrictions from the user. Conversation distribution restrictions may identify one or more of: who (e.g., users, client devices, tagged users, demographic based) can receive the conversation, what recipients can do within the conversation (e.g., reply, forward, and content types permitted to contribute), where the conversation is accessible (e.g., location based conversations), and when the conversation is accessible (e.g., time to live on the system, time to respond, time to send). After the conversation request is received, the process may continue to decision block 1704.

At decision block 1704, a determination is made as to whether the requested conversation involves blind carbon copy (BCC) as selected by the user. The BCC option may be chosen by the user when the user wishes to send a same conversation items to multiple other users without the other users discovering who else have received the same conversation items. If the BCC option is selected, the process may continue to block 1706. If the BCC option is not selected, the process may continue to block 1708.

At block 1706, viewing the recipients of other recipients of the conversation thread may be restricted in response to the selection of the BCC option by the user. After the viewing of the recipients is restricted, the process may continue to decision block 1708.

At decision block 1708, a determination is made as to whether the requested conversation is in a broadcast mode as chosen by the user. The broadcast mode may allow the user to establish a one-way conversation thread and send out a conversation item to other users while not allowing the recipients to reply back to the user's conversation item. If the requested conversation is in the broadcast mode, the process may continue to block 1710. If the requested conversation is not in the broadcast mode, the process may continue to decision block 1712.

At block 1710, the recipients of the conversation thread in the broadcast mode are restricted from replying in the conversation thread. After the recipients' replying options are restricted, the process may continue to decision block 1712.

At decision block 1712, a determination is made as to whether the requested conversation is in a locked mode. The locked mode may allow the user to establish a locked conversation thread with the recipients. In the locked mode, the recipients are restricted from adding any more participants to the conversation. If the requested conversation is in the locked mode, the process may continue to block 1714. If the requested conversation is not in the locked mode, the process may continue to block 1716.

At block 1714, the recipients of the conversation thread in the locked mode are restricted from adding new participants. After adding new participants is restricted, the process may continue to block 1718.

At block 1716, at least one user may be added. The recipients may add more participants to the conversation as the conversation thread is not locked. After adding at least one user to the conversation, the process may continue to block 1718. Optionally, a conversation thread may be created without adding another participant as in some implementations the content may be prepopulated. At a later time, additional participants may be added if the conversation thread is not locked, for example.

At block 1718, a conversation thread reflecting one or more conversation restrictions, if any, is created. The conversation thread may or may not have one or more restrictions described above in connection with the method shown in FIG. 17. After the conversation thread reflecting the user's choices is created, the process ends.

FIG. 18 is a flowchart for an exemplary method of pausing and unpausing a conversation thread in accordance with one embodiment. The method shown in FIG. 18 may be implemented in the conversation module 1140 in communication with the database 1120 such as that shown in FIGS. 11A-11B.

At block 1802, a conversation thread is created and a conversation between two or more users may begin. As a conversation thread participant may send a conversation thread item, the process may continue to block 1803.

At block 1803, a conversation thread item may be received. In one embodiment, one or more conversation participant may be disallowed from sending a conversation thread item for a paused conversation, and the conversation thread item may not be received if the conversation is paused. In another embodiment, the conversation thread item may be received for later transmission regardless of whether the conversation is paused as depicted in the method of FIG. 18. As a conversation thread participant may send a pause request in the first embodiment, the process may continue to decision block 1804.

At decision block 1804, a determination is made as to whether a pause request was received. The pause request may include an identifier for the conversation thread to be paused. If a pause request is not received, the process may continue to block 1810. If a pause request is received, the process may continue to block 1806.

At block 1806, the received conversation thread may be paused. In one embodiment, a conversation thread may be publically paused upon the conversation thread creator's request. In one embodiment, a conversation thread may be only privately paused upon any non-creator conversation participant's request. In another embodiment, the conversation may be publicly paused by any conversation participant's request. In one embodiment, the conversation thread may be configured by the thread creator to allow or disallow pausing by one or more of the conversation participants. After the conversation thread is paused, the process may continue to decision block 1808.

At decision block 1808, a determination is made as to whether an unpause request was received. The unpause request includes an identifier for the conversation thread. If an unpause request is received, the process may continue to block 1810. If an unpause request is not received, the process may continue to decision block 1812.

At block 1810, a conversation thread item may be received. When there is no pause request, a conversation thread item may be received. For a paused conversation thread, upon receipt of an unpause request, the conversation thread item of interest may be received. In one embodiment, a conversation publicly paused may be publicly resumed. In one embodiment, a conversation privately pause may be privately resumed as long as the conversation is not publicly paused. After the conversation thread item is received, the process may continue to decision block 1804 to determine receipt of a subsequent pause request.

At decision block 1812, a determination is made as to whether the conversation has ended. If the conversation has not ended, the process may continue to decision block 1808 to determine if an unpause request is made. If the conversation has ended, the method shown in FIG. 18 ends.

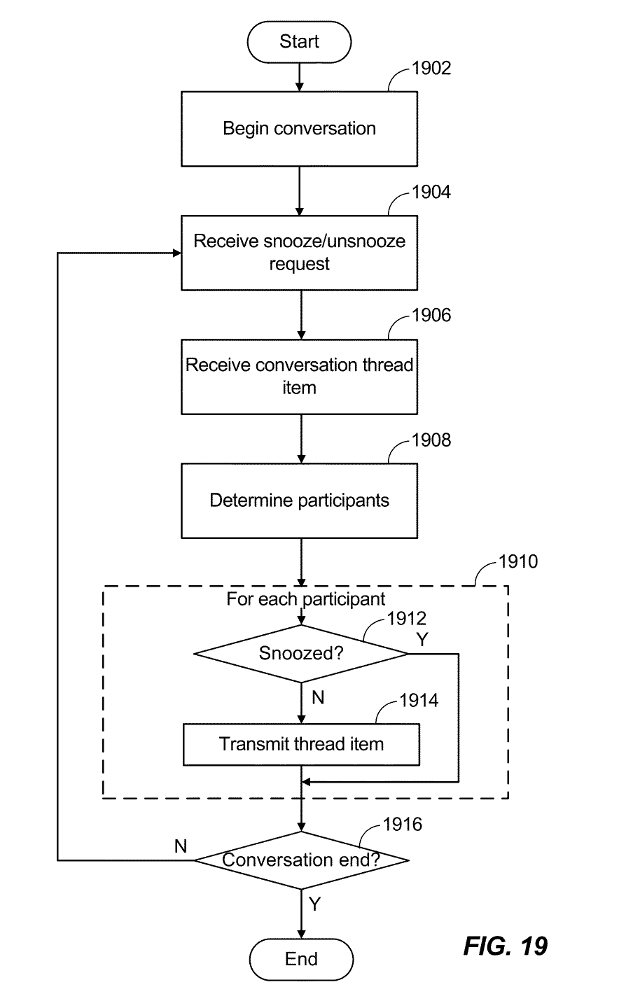

FIG. 19 is a flowchart for an exemplary method of snoozing a conversation thread in accordance with one embodiment. The method shown in FIG. 19 may be implemented in the conversation module 1140 in communication with the database 1120 in FIGS. 11A-11B.

At block 1902, a conversation between two or more users may occur through a conversation thread. The conversation thread may have been snoozed or unsnoozed by one or more of the participants of the conversation. As a conversation thread participant may send a snooze or unsnooze request, the process may continue to block 1904.

At block 1904, a snooze or unsnooze request may be received. As a conversation thread participant may send a conversation thread item, the process may continue to block 1906.

At block 1906, a conversation thread item may be received. After the conversation thread item is received, the process may continue to block 1908.

At block 1908, participants of the conversation thread may be determined. In one embodiment, the participants of the conversation may be determined based on which users are linked to the conversation thread in database 1120. After the conversation participants are determined, the process may continue to subprocess 1910 for each of the participant determined. For each participant, subprocess 1910 may continue to decision block 1912.

At decision block 1912, a determination is made as to whether the participant's conversation thread is snoozed. If the participant's conversation thread is snoozed, the subprocess 1910 ends for the participant. If the participant's conversation thread is not snoozed, the subprocess 1910 may continue to block 1914.

At block 1914, the conversation thread item is transmitted to the participant. Once the conversation thread item is transmitted to the participant, the subprocess 1910 may repeat for another participant determined at block 1908 until the subprocess 1910 is run for all the determined participants. Upon completion of subprocess(es) 1910, the process may continue to decision block 1916.

At decision block 1916, a determination is made as to whether the conversation has ended. If the conversation has not ended, the process may continue to block 1904 to receive a subsequent snooze or unsnooze request if any. If the conversation has ended, the method shown in FIG. 19 ends.

FIG. 20 is a flowchart for an exemplary method of deleting a conversation thread in accordance with one embodiment. The method shown in FIG. 20 may be implemented in the conversation module 1140 in communication with the database 1120 such as that shown in FIGS. 11A-11B.

At decision block 2002, a determination is made as to whether a conversation delete request is made. If a conversation delete request is not made by any conversation participant, the process may stay at decision block 2002. If a conversation delete request is made by a conversation participant, the process may continue to decision block 2004.

At decision block 2004, a determination is made as to whether the conversation delete requester is the author of the conversation thread. If the requester is the author, the process may continue to block 2006. If the requester is not the author, the process may continue to block 2008.

At block 2006, the conversation thread is deleted from database upon the conversation delete request from the author of the conversation thread. The database may be substantially similar to the database 1120 in FIGS. 11A-11B. In one embodiment, the author may be given options to delete the conversation from the database 1120, only delete from the author's device, and/or delete from other conversation participants' devices. In another embodiment, a delete request from the author of the conversation thread may delete the conversation thread from the database 1120 by default. In one embodiment, the client may initiate deletion of a conversation thread, but the server may maintain the conversation history for a period of time (e.g., 30 days) while flagging the conversation thread to be deleted. Once the conversation thread is deleted from the database 1120 or flagged as deleted in the database 1120, the process may continue to block 2010.

At block 2008, the conversation thread may be unlinked from the non-author requester's account in the database 1120. In one embodiment, the conversation may additionally be deleted only from the non-author's device. Once the non-author requester's account is unlinked from the conversation thread, the method of FIG. 20 ends.

At block 2010, the conversation thread may be deleted from all conversation participants' devices followed by the conversation author's delete request. In one embodiment, the non-author conversation participants may be given a notification that the conversation was deleted upon the author's request. In another embodiment, the non-author participants may not be given a notification regarding the deleted conversation. Upon deletion of the conversation thread from all participants' devices, the method of FIG. 20 ends.

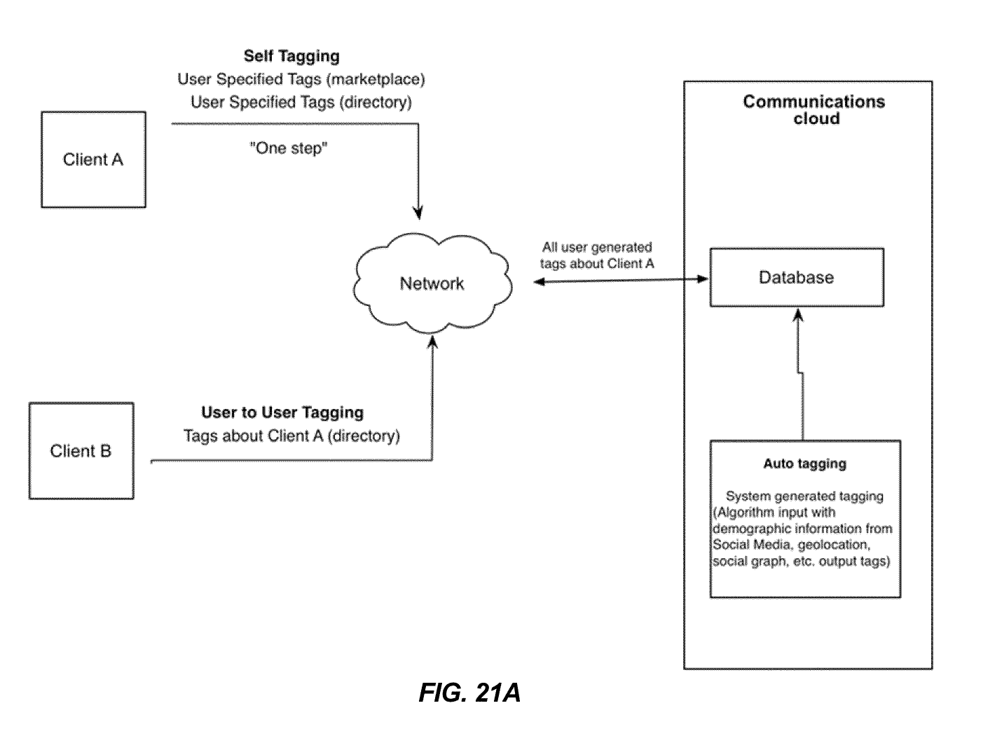

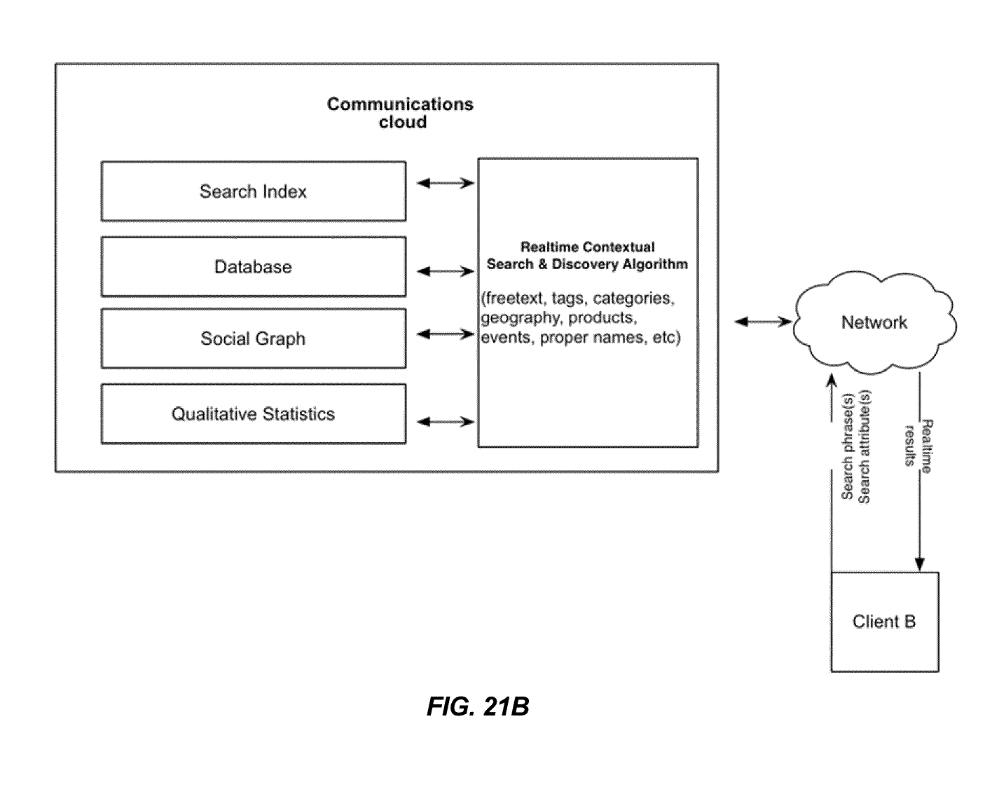

FIG. 21A is a functional block diagram of an exemplary communications network system in accordance with another embodiment. As illustrated in FIG. 21A, the first user, Client A, may generate public user specified tags in the “marketplace,” or private user specified tags in the “directory” specific to Client A. The second user, Client B may also generate tags including tags about other users such as Client A in this example. This tagging information may be communicated through a network and to a database of a communications cloud. The database also may have automatic, system-generated tags based on demographic information from social media, geolocation, and social graphs that the communications cloud may gather from the network. Thus, the system shown in FIG. 21A illustrates examples of the various sources for tags as well as the use of tags to facilitate providing a bidirectionally directed searchable marketplace and directory.

FIG. 21B is a functional block diagram of searching with an exemplary communications network system in accordance with another embodiment. The communications cloud may also comprise a search index module, database, social graph module, and qualitative statistics module that may operate in conjunction with a search module that implements a real-time contextual search and discovery algorithm using text, tags, categories, geography, products, events, and proper names, among others to perform searches. The communications cloud may communicate with users such as Client B in FIG. 21B through the network. Client B in this example may request a search based on one or more phrases or other search attributes. The communications cloud may perform the requested search through the search module and transmit real time results to Client B through the network. The tag information underlying the searches may be continually updated, such as discussed with reference to FIG. 21A. FIG. 21B illustrates how the information received from user about themselves (self tags) and about others (user to user tags) facilitate bidirectionally directed searches as the basis for the searches submitted by Client B consider both the self tags and user-to-user tags.

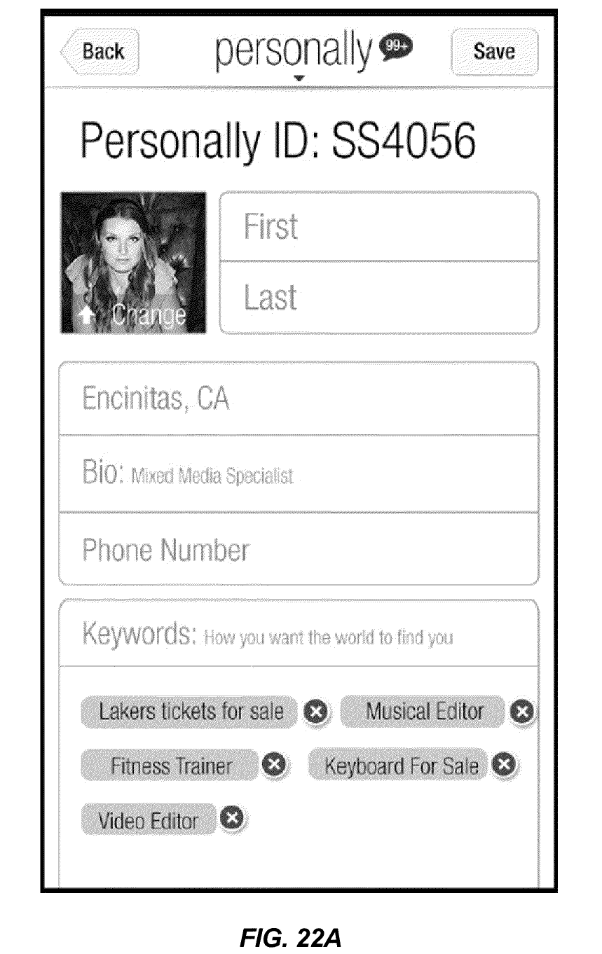

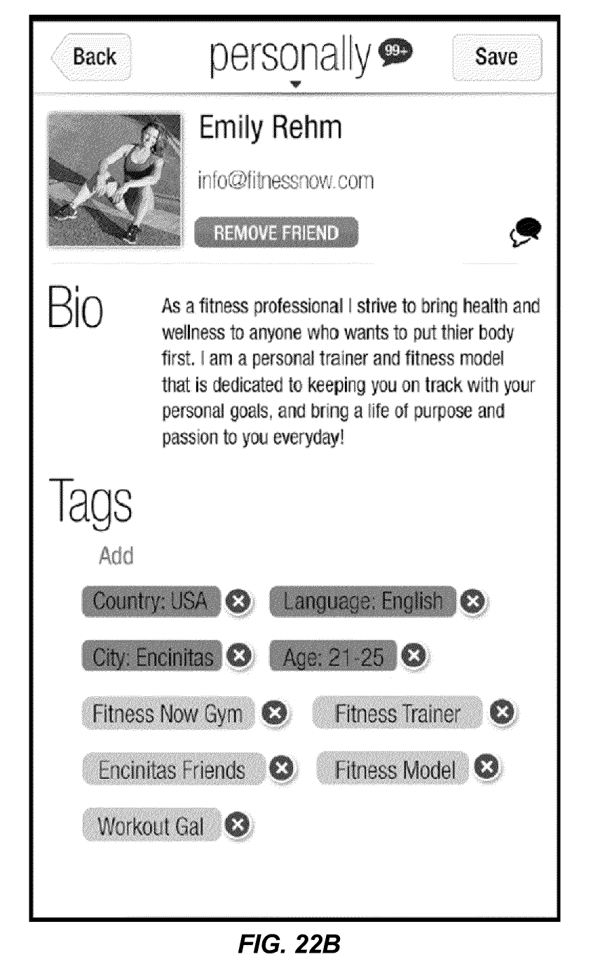

FIG. 22A is an exemplary user interface for a private user profile in accordance with one embodiment. The exemplary user interface illustrates public self tagging in accordance with one embodiment. Additionally, the exemplary user interface in FIG. 22A shows a user ID and entries for personal profile information, including first and last names, location, biographical information, phone number, and keywords or self-tags. In one embodiment, keywords or self-tags are public tags that may be short descriptions of the user publically available for others to view. In one embodiment, a user interface for public self tagging may include a suggestion field. In another embodiment, as the user types a public self-tags, the user may be prompted with suggestions. In one embodiment, the users may search and organize the user's public self-tags. In one embodiment, the users may delete the user's public self-tags, as illustrated in FIG. 22A with a circled-x icon next to each public self-tag. In one embodiment, the user may designate which group or groups may see which public self-tag. In one embodiment, the user may be given other options regarding public self-tags, such as expiration time or date.

FIG. 22B is an exemplary user interface for a public user profile in accordance with one embodiment. In the exemplary user interface, a profile of a user “Emily Rehm” is illustrated. The exemplary user interface illustrates the user's profile information including the user's contact information, biographical information, and tags. In one embodiment, automatic tags may be generated based on the user's online profile information, for example, as illustrated in FIG. 22B as “Country: USA,” “Language: English,” “City: Encinitas,” and “Age: 21-25.” In one embodiment, the automatically generated tags may by public tags viewable and searchable by others in the communication system. In another embodiment, the automatically generated tags may be searchable by others but not viewable by others along with the user's public profile. In the exemplary user interface, tags such as “Fitness Now Gym,” “Fitness Trainer,” “Encinitas Friends,” “Fitness Model,” and “Workout Girl” are self-tags. In one embodiment, self-tags are public tags that are viewable and searchable by others using the communication system disclosed herein. In one embodiment, each tag may be removed by selecting the delete symbol (a circled-x icon as in FIG. 22B) next to each tag.

In one implementation of the features described, a user may scan a barcode, QR code, or (unique ID) tag using a mobile device connected to a network (e.g., the Internet). The result of the scanning of the tag may trigger a threadsite to be displayed on the mobile device. A threadsite may be implemented as a real-time site including content such as videos, audio, and pictures, and text that would be useful to the user. Usefulness may be determined based on the user's context such as location, organizational affiliation, prior location, prior searches, training status, and the like. The user may to engage in a chat with members of the threadsite. In one embodiment, the threadsite may be a closed, chat broadcast from the organization maintaining the threadsite. The photos, videos, audio, and/or chat setting of the threadsite may be shown to the user via the mobile device. The user, via the interface displayed on the mobile device, may provide an input to toggle between the threadsite and the real-time chat session taking place which may populate the threadsite with content shared within the threadsite.

Various aspects of the novel systems, apparatuses, and methods are described more fully herein with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different data access technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

The interfaces shown represent example implementations of a tangible device configured to perform one or more of the features described. The interface elements may be implemented via the execution of machine readable instructions to generate a graphical representation of the interface on a device. The graphical representation may be, for example, a machine readable mark-up language (e.g., HTML), executable machine readable instructions (e.g., Javascript), or combinations of these or other display technologies. In some implementations, the interface may be constructed of physical components such as buttons, circuits, lights, and the like. The interface components may be controlled by a circuit configured to implement the methods described above. In some implementations, it may be desirable to control the interface components via a processor configured to execute stored instructions which cause the interface components to perform aspects of the methods described.

As used herein, the terms “display” or “displaying” encompass a variety of actions. For example, “displaying” may include presenting in audio form, visual form, or some other form that can be made known to the senses. The term may also include a combination of two or more of the foregoing.

As used herein, the terms “determine” or “determining” encompass a variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

It is to be understood that the claims are not limited to the precise configuration and components illustrated above. Various modifications, changes, and variations may be made in the arrangement, operation, and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1.-9. (canceled)

10. A method of displaying contextual content, the method comprising:
scanning a machine readable code with a mobile device connected to a network; and
triggering display of a threadsite using the machine readable code, wherein the threadsite is concurrently displayable on the mobile device and on another mobile device connected to the network, wherein the threadsite includes content comprising videos, audio, pictures, or text updated in real-time.

11. The method of claim 10, further comprising:
receiving updated content for the threadsite from the another mobile device; and
updating the display of the threadsite on the mobile device.

12. The method of claim 10, further comprising:
receiving chat content to be transmitted to the another mobile device; and
communicating the chat content between a user account associated with the mobile device and another user account associated with the another mobile device based at least in part on a conversation rule for the threadsite.

13. The method of claim 12, further comprising:
receiving the conversation rule from a host of the threadsite, wherein the conversation rule identifies at least one of:
available response actions to respond to the chat content;
a receipt time period identifying a period of time the chat content may be accessed; and
a response time period identifying a period of time during which an associated response action may be taken.

14. The method of claim 12, further comprising:
determining that the conversation rule indicates sharing of the chat content; and
updating the display of the threadsite to include the chat content.

15. The method of claim 12, further comprising triggering a second display including the chat content and a first control element that, when activated, triggers display of the threadsite, wherein the threadsite further includes a second control element that, when activated, triggers the second display.

16. The method of claim 10, further comprising:
receiving chat content from a host of the threadsite to be transmitted to at least the mobile device and the another mobile device;
communicating the chat content to a user account associated with the mobile device and another user account associated with the another mobile device;
receiving a reply to the chat content from the mobile device; and
suppressing transmission of the reply to the another mobile device.
